(19) United States
(12) Patent Application Publication
(10) Pub. No.: US 2023/0222942 A1
(43) Pub. Date: Jul. 13, 2023

(54) FORCE PERCEPTION MECHANISM FOR PHYSICAL LAPAROSCOPIC SIMULATION MODELS

(71) Applicant: Applied Medical Resources Corporation, Rancho Santa Margarita, CA (US)

(72) Inventors: Daiane Aizen Grill, Rancho Santa Margarita, CA (US); Gregory K. Hofstetter, Rancho Santa Margarita, CA (US)

(21) Appl. No.: 18/094,804

(22) Filed: Jan. 9, 2023

Related U.S. Application Data
(60) Provisional application No. 63/297,392, filed on Jan. 7, 2022.

(51) Int. Cl. G09B 23/28

(52) U.S. Cl. CPC G09B 23/285

(57) ABSTRACT

A simulated training model having a force perception mechanism to identify and notify to a user when an amount of force being applied to the model exceeds a pre-determined amount. The force perception mechanism has two states that are used to identify when an amount of force being applied to the model exceeds the pre-determined amount. In a first state, one or more portions of the simulated training model are removably connected to each other; for example the body to the base and/or the post to the body. The second state corresponds to when one or more of the portions of the simulated training model become detached from each other. When the transition occurs between the first state to the second state, the surgical training model informs the user that the force being applied to one or more of the portions of the simulated training model had exceeded the pre-determined amount.

### CROSS-REFERENCE TO RELATED APPLICATIONS

This application claims priority to and benefit of U.S. Provisional Patent Application Ser. No. 63/297,392 entitled “Force Perception Mechanism for Physical Laparoscopic Simulation Models” filed on Jan. 7, 2022 which is incorporated herein by reference in its entirety.

### FIELD OF INVENTION

The present application generally relates to surgical training systems, and, more particularly, to force perception mechanisms for physical laparoscopic simulation models.

### BACKGROUND OF INVENTION

A variety of challenges arise when a user (e.g., surgeon) performs laparoscopic surgery relying on the use of laparoscopic instruments to indirectly manipulate tissue. These laparoscopic instruments have a variety of features (e.g., force artifacts) that would prevent the user from receiving certain form of feedback (e.g., haptic) that would allow the user to sense how much force is being applied to the tissue during the surgical procedure. Thus, an amount of force being applied by the user onto the laparoscopic instrument may not directly correspond to an amount of force being applied to the tissue by the laparoscopic instrument. If too much force is applied to the tissue during the course of the surgical procedure, the excessive force can cause trauma to the tissue.

Thus, there is a need for a surgical training system that provides training to the users to accurately estimate the amount of force being applied to the tissue relative to the force being applied by the user on the laparoscopic instrument. Furthermore, the surgical training system for training the application of force can be implemented without the use of electronics (e.g., sensors and digital displays).

### SUMMARY OF THE INVENTION

In accordance with various embodiments a surgical training model is described herein. The model has a force perception mechanism having a first state and a second state. In the first state, the force perception mechanism is at least partially attached to the model. In the second state, the force perception mechanism is detached from the model. The transition between the first and second states is used to notify a user when an amount of force being applied to the model exceeds a pre-determined amount.

In accordance with various embodiments another surgical training model for developing and practicing skills associated with laparoscopic surgical procedures is described. The model has a post and a force perception mechanism. The force perception mechanism corresponds to a peg and a body of the model. When in a first state, the peg is connected to the body. In a second state, the peg is detached from the body. The transition from the first state and the second state is used to notify a user when an amount of force being applied to the model (to the post or some part of the body) exceeds a pre-determined amount.

In accordance with various embodiments, another surgical training model is described. The model has a base and a body. The body (or at least a portion of the body) is removably attached to the base at pre-determined locations. The model is made to have two different states. While in a first state, the body is attached to the base at the pre-determined locations. In the second state, the body (or at least a portion of the body) is detached from the base at least one of the pre-determined locations. The transition between the first state and the second state informs a user that the force being applied to the model exceeds a pre-determined amount.

In accordance with various embodiments, another surgical training model is described. The model has a base, a post, and one or more flaps. The flaps are connected on one end to the post and are removably connected on an opposite end to the base. In a first state of the model, the one or more flaps are connected to the base at pre-determined locations. In a second state of the model, at least one of the flaps are detached from the base. A transition from the first state to the second state notifies a user when an amount of force being applied to the post exceeds a pre-determined amount.

In accordance with various embodiments, another surgical model is described. The surgical model has a base, a post, and at least one indicator on the post. The model in a first state has the at least one indicator in a rest position with respect to the base and the post. The model in a second state has the at least one indicator moved away from the rest position further than a pre-determined distance. A transition from the first state to the second state notifies a user when an amount of force being applied to the post exceeds a pre-determined amount.

In accordance with various embodiments, another surgical model is described. The surgical model has a base, a post that is removably connected to the base, and strips that also connect between the base and the post. The model in a first state has the post resting on the base. The model in a second state has the post detached from the base and pulled a pre-determined distance above the base. A transition from the first state to the second state notifies a user when an amount of force being applied to the post exceeds a pre-determined amount.

In accordance with various embodiments, another surgical model is described. The surgical model has a base having pegs at pre-determined locations and a post having one or more holes at pre-determined locations. In a first state of the model, the one or more holes are removably connected to the pegs at the pre-determined locations. In a second state, one or more of the holes are detached from their respective pegs. A transition from the first state to the second state notifies a user when an amount of force being applied to the simulated surgical model exceeds a pre-determined amount.

In accordance with various embodiments, another surgical training model is described. The surgical training model has a force perception mechanism that is associated with a post of the model. The force perception mechanism has a first state and a second state. In the first state, the force perception mechanism is hidden from a user. In the second state, the force perception mechanism is made visible to the user. A transition from the first state to the second state notifies a user when an amount of force being applied to the post exceeds a pre-determined amount.

In accordance with various embodiments, another surgical model is described. The model has a base and a post that is removably connected to the base. While in a first state, the model has the post being removably connected to the base at pre-determined locations. In a second state, the post becomes detached from the base. A transition from the first state to the second state notifies a user when an amount of force being applied to the post exceeds a pre-determined amount.

In accordance with various embodiments, another force perception mechanism is identified. The force perception mechanism has a first and second state. In the first state, a portion of the model is removably connected to a different portion of the same model. In the second state, the portion of the model is detached from the different portion of the same model. A transition from the first state to the second state notifies a user when an amount of force being applied to the model exceeds a pre-determined amount.

In accordance with various embodiments, another surgical training model is described. The model has a force perception mechanism associated with a post of the model. The force perception mechanism also has a first and second state. In the first state, the force perception mechanism is hidden from view of a user. In the second state, the force perception mechanism is made visible to the user. A transition from the first state to the second state notifies a user when an amount of force being applied to the post exceeds a pre-determined amount.

In accordance with various embodiments, another force perception mechanism is described. The force perception mechanism has an indicator that is associated with a portion of the model. While in a first state, the indicator is hidden from view of a user. In a second state, the indicator is made visible to the user. A transition from the first state to the second state notifies a user when an amount of force being applied to the post exceeds a pre-determined amount.

### BRIEF DESCRIPTION OF THE DRAWINGS

The present invention may be understood by reference to the following description, taken in connection with the accompanying drawings in which the reference numerals designate like parts throughout the figures thereof.

FIG. 1A and FIG. 1B illustrate exemplary surgical training models comprising a body, a base, a post, and a force perception mechanism.

FIG. 2 illustrate exemplary openings associated with the body of the surgical training model.

FIG. 3 illustrate an exemplary embodiment of a force perception mechanism.

FIG. 4A-FIG. 4C illustrate exemplary embodiments of a surgical training model whereby the post interfaces with the body.

FIG. 5A and FIG. 5B illustrate exemplary embodiments of the post being connected/affixed to the body.

FIG. 6 illustrates an example user interaction with the post of the surgical training model.

FIG. 7 illustrate an exemplary embodiment of the body that would interface with the post.

FIG. 8A and FIG. 8B illustrate an exemplary embodiment of the surgical training model with a force perception mechanism using two or more pegs.

FIG. 9A and FIG. 9B illustrate an exemplary embodiment of the surgical training model with a force perception mechanism using a tether.

FIG. 10 illustrates an exemplary embodiment of the surgical training model with a force perception mechanism that removably connects a portion of the body with slot-shaped openings in the base.

FIG. 11A-FIG. 11C illustrate an exemplary embodiment of the surgical training model with a force perception mechanism using a combination of a tether and a peg.

FIG. 12A and FIG. 12B illustrate exemplary embodiments of the surgical training model with a force perception mechanism using a tether with an indicator.

FIG. 13A and FIG. 13B illustrate exemplary embodiments of the surgical training model with a force perception mechanism using a ring or washer associated with the post.

FIG. 14 illustrates an exemplary embodiment of the surgical training model with a force perception mechanism using a plurality of strips that are associated with the post.

FIG. 15A and FIG. 15B illustrate exemplary embodiments of the surgical training model with a force perception mechanism using one or more flaps associated with the post that are connected to pegs associated with the base.

FIG. 16A and FIG. 16B illustrate exemplary embodiments of the surgical training model with a force perception mechanism using an attachment or a platform associated with the post to connect the post with the base.

FIG. 17 illustrates an exemplary embodiment of the surgical training model with a force perception mechanism using a protrusion with a portion of the post.

FIG. 18 illustrates an example embodiment of a laparoscopic trainer.

FIG. 19 illustrates an example performance of a laparoscopic training task using an embodiment of the surgical training model described herein.

### DETAILED DESCRIPTION

In accordance with various embodiments, different surgical training systems are illustrated in the figures and described as follows. The surgical training model is usable to train various skills related to surgical procedures. In various embodiments, the surgical training systems may incorporate a force perception mechanism. Although there are a number of ways of implementing the force perception mechanism with a surgical training model, each of the force perception mechanisms described in this application are configured to provide a way to indicate when the user (for example, via the use of laparoscopic instruments) is applying a force greater than a pre-determined threshold during the simulated surgical task being performed on the surgical training model. The pre-determined threshold associated with the force perception mechanism can be customized to correspond to a force threshold in which tissue trauma could occur during an actual laparoscopic procedure. Furthermore, the surgical training system (via the force perception mechanism) is designed to notify the user when excessive force was detected without the use of any electronics (e.g., sensors).

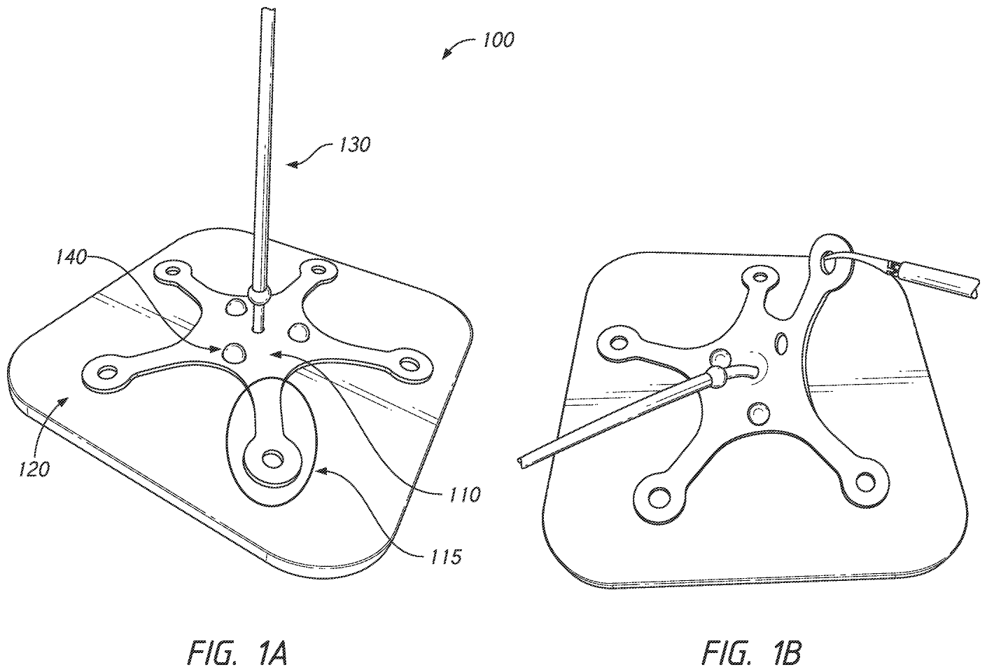

In various embodiments, a force perception mechanism is provided by adding additional components and/or making modifications to a surgical training model that allows the amount of force to be gauged by the surgical training model. An exemplary surgical training model 100 (as illustrated in FIG. 1A) comprises of at least a body 110, a base 120, and a post 130; although other embodiments may include more or less components. With a force perception mechanism 140 (incorporated via the pegs) provided with and/or incorporated into a surgical training model 100, users are able to monitor and be notified when an excessive amount of force is being exerted by the user during the course of the performance of a laparoscopic training task with the surgical training model 100. Furthermore, the monitoring and notification regarding the amount of force is performed without the use of electronics such as sensors.

The force perception mechanism 140 is designed to configure portions of the surgical training model 100 to respond to forces being applied by the user while the user performs a laparoscopic training task. Before the start of a laparoscopic training task, the surgical training model 100 is provided in an initial rest state. As the user exerts force on the surgical training model 100 during the performance of the laparoscopic training task, the surgical training model 100 transitions to an intermediate state where portions of the surgical training model 100 will respond and react to the force causing those portions of the surgical training model 100 to move, stretch and/or disengage with other portions of the surgical training model 100. However, when an excessive amount of force is exerted by the user on the surgical training model 100, the changes to the surgical training model 100 transitions the surgical training model 100 to a transformed state. In various embodiments, the transformed state can render the surgical training model 100 inoperable for further use in connection with the laparoscopic training task until the surgical training model 100 is reset. Thus, the transformed state is used as one of the ways to notify the user that an excessive amount of force was used while performing the laparoscopic training task.

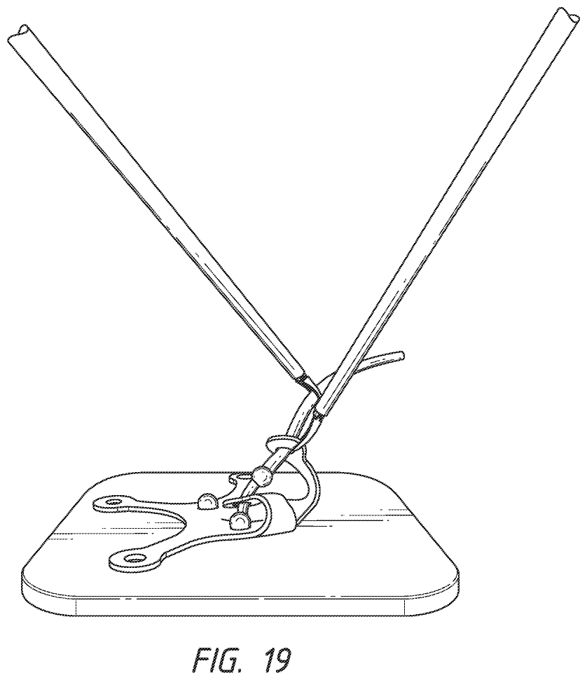

As described herein, laparoscopic training tasks are tasks that can be performed with the surgical training models 100 with the aim of developing and practicing skills associated with laparoscopic surgical procedures. In general, laparoscopic training tasks are designed for practicing one or more different steps or skills associated with laparoscopic surgical procedures. In an exemplary laparoscopic training task, the user uses or is instructed to use both hands in order to control a limb 115 (with one hand using a surgical device) and a post 130 (with the other hand using a different surgical device) associated with a surgical training model 100 (see FIG. 1A or FIG. 19). As described herein, in various embodiments, a limb 115 refers to a portion of the body 110.

With both the limb 115 and the post 130, the user maneuvers or is directed to maneuver the post 130 through an opening associated with the limb 115 or vice versa. FIG. 19 illustrates an example performance of this laparoscopic training task where two different surgical devices (e.g., graspers) are shown to control and maneuver the limb 115 and the post 130 as described above.

Without the force perception mechanism 140, a user will generally be unaware of an amount of force that is being applied while using different laparoscopic surgical devices with the surgical training model 110. That is because the amount of force that the user applies to the proximal end of the laparoscopic device does not translate exactly to the force the tip of the same device is applying (i.e., the end interacting with the tissue). During an actual surgical (e.g., laparoscopic) procedure, an excessive amount of force to an area of tissue may cause trauma and/or damage to that area of tissue. Thus, training a user to learn and/or a user learning a relationship between an amount of force being applied to a laparoscopic device and the corresponding force on the other end of the laparoscopic device being used is important in order to prevent the use of excessive force.

In various embodiments, the surgical training model 100 is designed to be resettable by the user, reverting the surgical training model 100 from the transformed state back to its initial and/or an intermediate state. By resetting the state of the surgical training model 100 (and the force perception mechanism 140 implemented therein) back to the initial state, users are able to repeat and re-attempt the laparoscopic training task using the same surgical training model 100. The “reset” capability is possible due to the reversible nature of the components associated with the surgical training model 100 and the force perception mechanism 140 and how these components interact with one another.

In various embodiments, a force perception mechanism 140 is provided in which modifications are made to parts (e.g., body 110, base 120, post 130) of a surgical training model 100. In various embodiments, such modifications may include adding additional components or structures (e.g., pegs, tethers, flaps, platforms, or combinations thereof) that are either attached to portions of a surgical training model 100 or manufactured with a surgical training model 100 as one monolithic structure. Modifications may also include changing aspects of existing features of a surgical training model 100 in order to interface with the additional structures. For example, the body of a surgical training model 100 may include openings that can be configured to interface with pegs (see FIG. 1B); and the post 130 may include protrusions or markings that are usable to gauge an amount of force being exerted therein. In another example, the base 120 may now include slots that allow the additional structures of the force perception mechanism 140 to be removably attached.

In various embodiments, the location of the additional structures (e.g., pegs, tethers, flaps, platforms, or combinations thereof) may be varied. For example, the additional structures may be associated near the center of a surgical training model 100 (e.g., near the post 130); some structures may be associated with the body 110; some structures may be associated with just the post 130; some with both.

As the user interacts with the surgical training model 100 such as performing a laparoscopic training task, portions of the surgical training model 100 may change. For example, user interaction with one of the limbs 115 of the body 110 may cause portions of the body 110 (e.g., limb 115) to stretch. These interactions with the surgical training model 100 change the state of the surgical training model 100 between the initial state, to an intermediate state, and possibly to a transformed state.

In an initial state, no force is being exerted on the surgical training model 100 thus having the various components of the surgical training model 100 at rest. In this initial state, the additional structures and/or other portions of the surgical training model 100 (e.g., body 110, base 120, post 130) are connected and/or secured in place.

In the intermediate state, some force is being applied to portions of the surgical training model 100. Despite the force, the additional structures are still in contact/connected with their respective components of the surgical training model 100. While in the intermediate state, user applied force is considered appropriate.

Lastly, the transformed state corresponds to when one or more of the components of the surgical training model 100 associated with the force perception mechanism become disengaged/detached from their respective additional structures or otherwise move in a pre-determined manner. With the occurrence of the transformed state, the force perception mechanism 140 has identified that excessive force has been used. Furthermore, the transformed state is used as a form of notification to the user that the user has used an excessive amount of force corresponding to a failure in the laparoscopic training task.

In various embodiments, the connection between the additional structures (e.g., pegs, tethers, flaps, platforms, or any combination thereof) associated with the force perception mechanism 140 with the components of the surgical training model 100 use frictional forces in order to characterize the user applied force and identify when an excessive amount of force has been used. The frictional force act as a counter/opposite force to the user applied force on portions of the surgical training model 100. However, if an amount of force being applied to the surgical training model 100 is greater than the present frictional force, the user applied force will cause the state of the surgical training model 100 to change.

In various embodiments, the frictional force present within the surgical training model 100 can be customized. The type of materials used to make up the surgical training model 100, for example can impact the model's elasticity (i.e. stretchability) which affects how much user applied force can be “absorbed” by the surgical training model 100. The materials can also have different surface roughnesses which can increase or decrease the frictional force present between two moving surfaces. Other factors that can influence the frictional force include but are not limited to the relative sizes/cross-sectional areas of the additional structures (e.g., pegs, tethers, flaps, platforms, or any combination thereof) in comparison to portions of the surgical training model 100 that they interact with them (e.g., openings in the body, slots in the base). Furthermore, the size and shape of the additional structures can also impact the amount of frictional force.

As the user applies force to the surgical training model 100, portions of the user applied force will be “absorbed” while the rest will be transferred towards the locations where the additional structures are positioned on the surgical training model 100. The frictional force present at the locations where the additional structures are located counteracts the user applied force (keeping the surgical training model in the intermediate state). At some point, an amount of force being exerted on the surgical training model will exceed the frictional force present at one or more different locations where the additional structures are located. When that point occurs, portions of the surgical training model will become disengaged (e.g., pulled off) from the additional structure (e.g., peg, tether). Thus, to identify the occurrence of the excessive user applied force, the force perception mechanism 140 uses the occurrence of the surgical training model 100 disengaging from the additional structure to signal to the user that excessive force has been detected.

In various embodiments, the disengagement of portions of the surgical training model 100 from the additional structure causes that portion (or the entirety of) the surgical training model 100 to change into a transformed state. In various embodiments, the transformed state corresponds to changes in the surgical training model 100 that are used to identify that an excessive force has been detected and to inform the user of the same. In various embodiments, the transformed state may also render the surgical training model 100 inoperable to prevent further performance of the laparoscopic training task. Thus, the surgical training model 100 is configured to respond to the user applied force by having two or more different features (e.g., the additional structure and a corresponding component or portion of the surgical training model 100) interact and become disengaged with respect to each other. The response (e.g., detachment) is used to identify and subsequently notify the user of its occurrence.

In various embodiments other means of feedback may also be possible aside from just being visual (as described above). For example, the surgical training model 100 may be configured to provide audio feedback. In various embodiments, movement and/or disengagement of the additional structure from the surgical training model 100 may create a sound (e.g., a pop sound) that can be used to notify the user. In various embodiments, the surgical training model 100 may be configured to provide haptic feedback. For example, the surgical training model 100 may provide haptic feedback (e.g., a sudden movement, jolt or shock) at the point when one or more additional structures move or become disengaged from the surgical training model.

In various embodiments, components of or portions of the surgical training model 100 and/or the additional structures that facilitate in the implementation of the force perception mechanism 140 may be interchangeable with other variations. For example, a body 110 with more or less openings or openings of different sizes can be used instead. Furthermore, pegs of different sizes and shapes can also be used. Tethers having different length and elasticity can be used. The interchangeability provides customization of the predetermined force threshold associated with the force perception mechanism 140 for the surgical training model 100.

With reference back to FIG. 1A and FIG. 1B, these figures illustrate an exemplary surgical training model 100 with a force perception mechanism 140. The surgical training model 100 (as illustrated in FIG. 1A) comprises a post 130, a body 110 (with one or more limbs 115), and a base 120. The force perception mechanism 140 operates based on interactions between the additional structures (e.g., pegs) and modifications made to the body 110 (e.g., openings to receive one end of the pegs).

An initial set up for the surgical training model 100 (corresponding to an initial state), has each of the pegs inserted through a respective opening of the body 110 (see FIG. 1A). It should be noted that the arrangement and the number of pegs and/or openings of the body 110 as illustrated in FIG. 1A can differ. In various embodiments, having the pegs and openings in different locations may configure the surgical training model 100 to focus on detecting forces at a particular portion of the surgical training model 100. In various embodiments, having more or less pegs and openings may affect how the user applied force is responded to thereby affecting the pre-determined force threshold for the surgical training model 100 as a whole.

Once connected, the arrangement between the body 110 of the surgical training model 100 and the pegs correspond to an initial state where the body 110 of the surgical training model 100 is removably connected with the pegs. The connection with the pegs temporarily secures the body 110 to the base 120 of the surgical training model 100 via an interference fit until a user applied force causes at least a part of the body 110 to disengage from one or more pegs.

The interaction (e.g., connection) between the openings in the body 110 and the pegs is used to detect user applied force to the surgical training model 100 (e.g., the limbs); especially when an excessive amount of force has been applied by the user. As the user interacts with the body 110 (e.g., limb), a portion of the force being applied to the body 110 may be transferred towards the pegs that causes or may cause the disengagement of the body 110 from the pegs. Based on the material of the body 110 (e.g., elasticity), some of the force may be “absorbed” via the stretching of the body 110. However, at some point, the material may be incapable of “absorbing” all of the user applied force. At that point, the user applied force will be transferred towards a portion of the body 110 connected to the peg.

As mentioned above, frictional force is present as a counter to the user applied force as a result of the interference fit between the openings in the body 110 and the pegs; and is configured to prevent the body 110 from moving and disengaging from the peg. An amount of frictional force present between the body 110 and the peg, in various embodiments, originates from the type of connection between the two. For example, if the cross-sectional area of the peg is the same as or larger than the cross-sectional area of the opening in the body 110, the type of connection between the body 110 and the peg may be an interference-type fit. The amount of frictional force in the interference-type fit will depend on the ratio between the cross-sectional area of the opening and that of the peg.

However, at some point, the user may assert an amount of force that is greater than the frictional force present between the body 110 and the peg (i.e. friction threshold) at which point the user applied force will cause the portion of the body 110 to disengage from the peg. In some embodiments, when the user applied force on at least a portion of the surgical training model 100 (e.g., body 110, post 130) exceeds the frictional force between the body 110 and the peg, that portion of the body 110 may become detached from the corresponding pegs. FIG. 1B illustrates an exemplary scenario where a user applied force to one of the limbs 115 causes the body 110 to become detached from one of the pegs near that limb 115. If further force is applied to the same limb 115, the body 110 may become detached from one or more other pegs associated with the body 110.

The detachment of the body 110 from one or more of the pegs is used to notify to the user that an excessive amount of force has been used on at least a portion of the surgical training model 100. This notification corresponds to a scenario where during an actual surgical procedure the user may have caused trauma to the tissue being operated on based on the amount of force that was applied.

In various embodiments, the detachment of the body 110 from one or more of the pegs may be a visual notification to the user that an excessive amount of force was detected. In addition, the detachment of the body 110 from one or more of the pegs causes the surgical training model 100 to transition to a transformed state that can also be used to notify that the user has exerted an excessive amount of force onto a portion of the surgical training model 100. In particular, the transformed state may render part or all of the surgical training model 100 to be inoperable thereby preventing the user from continuing on with the laparoscopic training task. In some embodiments, the detachment of the body 110 from one or more pegs can also include other indicators that are haptic and/or auditory in nature usable to also inform the user that excessive force has been detected.

In various embodiments, the predetermined force threshold, which represents an allowable amount of force that the user can exert before possibly causing trauma or damage to tissue during a surgical procedure, can be made to correspond to the frictional force present between the body 110 and the pegs. Thus, the predetermined force threshold can be customized by controlling how much frictional force is present between the body 110 and the peg. This customization allows the surgical training model 100 to be adapted to different surgical procedures and/or be applicable to different types of tissue where different forces can be acceptable without causing tissue trauma.

In various embodiments, the force perception mechanism 140 is customizable in which users are able to customize the amount of frictional force present between the body 110 and the peg. For example, the pegs may be interchangeable with other variations (e.g., different dimension, shapes) of pegs thereby providing different interference fits that would in turn correspond to different amounts of force needed to disengage the body 110 from the peg. The changes in the size of the pegs can affect the connection (or fit) with the openings in the body 110 which impacts the frictional force present.

In various embodiments, different bodies 110 may be interchanged that have different degrees of elasticity. Elasticity affects how much user applied force can be “absorbed” before being transferred towards the pegs. Thus, a differing amount of user applied force would be needed to disengage the body 110 from the peg.

In accordance with various embodiments, the surgical training model 100 is configured to be “resettable” back to its initial state at any time. At least based on the embodiment illustrated in FIG. 1A and FIG. 1B, the “reset” is implemented by inserting the detached portion of the body 110 back onto the corresponding pegs. This allows users to repeat the laparoscopic task and reuse the same surgical training model 100.

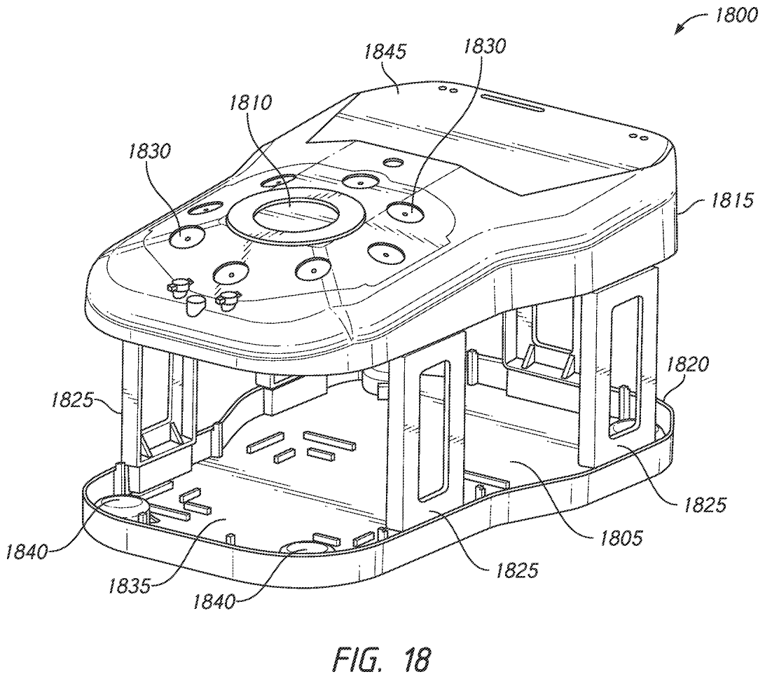

Using the exemplary surgical training model 100 illustrated in FIG. 1A, the surgical training model 100 can be housed within a laparoscopic/surgical trainer 1800 (discussed below in FIG. 18) which may be configured to simulate laparoscopic conditions. Such an embodiment where the surgical training model 100 is housed within a surgical trainer 1800 can be seen in FIG. 19. In some embodiments, the surgical training model 100 can be placed within the body cavity 1805 of the laparoscopic trainer 1800 (e.g., on a removable tray). In some embodiments, the surgical training model 100 can be removably attached to the bottom of the laparoscopic trainer 1800 via the base 120 of the surgical training model 100, for example, via the use of hooks and loops in order to secure the position of the surgical training model 100 and prevent movements during a laparoscopic training task.

In some embodiments, the body 110 of the surgical training model 100 is separate from a base 120. Because the body 110 is generally laid on top of the base 120, a “stickiness” between the base 120 and the body 110 (which causes the base 120 and the body 110 to be attached or at least partially adhered to each other) may indirectly influence increase the force needed to dislodge the body 110 from one or more of the pegs, increasing the overall force threshold of the force perception mechanism 140. However, in various embodiments, by introducing a surface texture to the base 120 which minimizes or eliminates the “stickiness” between the base 120 and the body 110, the pegs (which are connected/anchored to the base) can be made to be the main connection point between the body 110 and the base 120. Thus, the surface texture on the base 120 ensures that the base 120 does not impact the amount of frictional force present between the body 110 and the pegs.

As discussed above, the force threshold can be adjusted/customized to correspond to different force thresholds in order to simulate the delicacy of different tissue or acceptable forces for different surgical procedures before potentially causing trauma or damage to tissue from excessive force from the user. In various embodiments, the force thresholds can be adjusted in any number of different ways. For example, the force threshold can be adjusted if centered around the type of connection between the body 110 and the components used for implementing a force perception mechanism 140. Other ways may include but are not limited to modifying the diameter or cross-sectional area of the component implementing the force perception mechanism 140 with respect to the diameter or cross-sectional area of the opening in the body 110, adjusting the surface texture of the body 110 and/or the component implementing the force perception mechanism which may introduce additional friction (which adds additional resistance to the act of the body 110 disengaging from the component implementing the force perception mechanism), introducing a draft and/or adjusting the height of the peg, adjusting the fillet radius of the peg, adjusting the elasticity of the body material (which affects the stretchability/deformity of the body 110 and in turn the openings), and/or any combinations thereof.

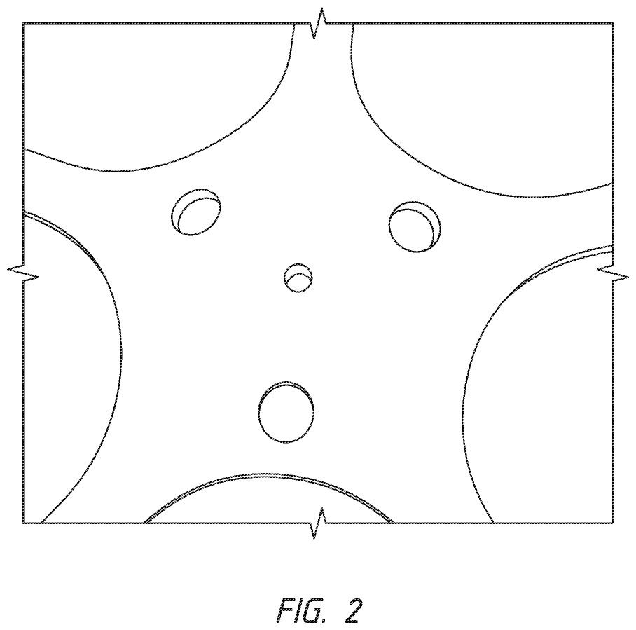

By changing the diameter and/or cross-sectional area of the opening and/or the component implementing the force perception mechanism 140, the type of connection (e.g., interference fit) between the body 110 and the components can be adjusted. This in turn can provide changes between the connection of the body 110 and the components such as introducing an amount of additional frictional force needed to overcome to have the body 110 disengage from the components. In some embodiments, the diameter of the opening in the body 110 that is adapted to receive the pegs can be around 7/32 inches- 17/64 inches for a 5/16 inch diameter peg. Exemplary openings in the body 110 of the surgical training model 100 can be seen, for example, in FIG. 2. These openings associated with the body 110 are adapted to interface with the pegs. To change/adjust the force threshold, different bodies 110 can be interchanged having differently designed openings (e.g., openings with different cross-sectional areas) that would interface with the components (such as pegs) differently.

In various embodiments, portions of the surgical training model 100 that facilitate in the implementation of the force perception mechanism 140 (e.g., pegs) may be manufactured (e.g., molded) separately from the surgical training model 100 (e.g., base 120) and subsequently attached (e.g., to the base 120). In various embodiments, those same portions (e.g., pegs) can be molded with the surgical training model 100 (e.g., base 120) as a single monolithic structure.

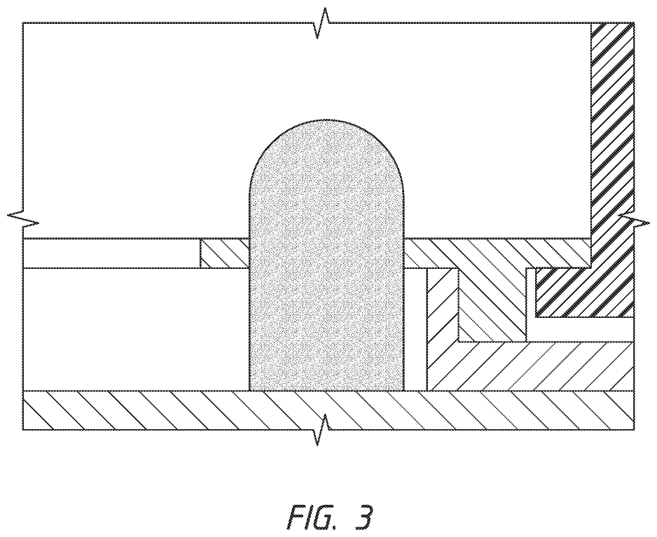

FIG. 3 illustrates an exemplary embodiment of a component being used to implement the force perception mechanism 140 for a surgical training model 100. In particular, the component is a peg that is configured to be in contact with the body 110. The diameter of the peg can be around 5/16 inches but can be adjusted in correlation with the size of the opening of the body 110 in order to achieve a desired force threshold thereby creating a type of interference fit connection between the peg and body 110.

Furthermore, changes in the surface texture of the body 110 and/or peg can also affect a frictional force between the body 110 and the peg. Because the surfaces between the body 110 and the peg are pressed together, the texture of the surfaces may make it harder or easier for the surface of the body 110 in contact with the peg to move relative to the latter. For example, if the peg and the opening of the body 110 both have rough surfaces, the relative movement between the body 110 and the peg will introduce additional friction that can increase the required force to disengage the body 110 from the peg. However, if both the opening of the body 110 and the peg are smooth, there may be little to no additional friction as the surfaces slide with the movement caused by the force exerted by the user. Thus, the body 110 may be more easily disengaged from the peg compared to embodiments having rough surfaces.

With respect to introducing a draft for the peg, this occurs when the vertical portions of the peg become more angled corresponding to changes in the diameter of the peg along the length of the peg. A positive draft means the diameter of the peg becomes smaller going from the bottom of the peg to the top of the peg. The positive draft would progressively decrease the friction force as the body 110 is being pulled since the interference fit towards the top of the peg becomes looser. A negative draft corresponds to the opposite scenario where the friction force would increase as the body 110 is being pulled towards the top of the peg.

By adjusting a distance the body 110 would need to travel along a peg before becoming detached/disengaged from the peg, such modifications can also be used to adjust the force threshold as well. The distance traveled by the body 110 can be affected by changing the height/length of the peg thereby affecting the surface area the body would be in contact with before becoming detached. For example, the height of a peg could be between 0.25 inches to 0.45 inches above the surface of the base 120. Increasing the height, for example, can require the user to maintain and/or increase an amount of force being exerted on the body 110 for a longer period of time thereby making the body 110 harder to detach from the peg. Conversely, embodiments where a shorter height is used for the peg would make the body 110 easier to detach from the peg because of the lesser amount of force that is required to move the body 110 to disengage from the peg. Furthermore, the initial placement/positioning of the opening along the height of the peg (e.g., near the bottom vs the middle of the peg) can similarly affect the length the body 110 would have to travel before becoming detached from the peg by a force being exerted onto the body 110 by the user (e.g., grasper pulling on the body 110).

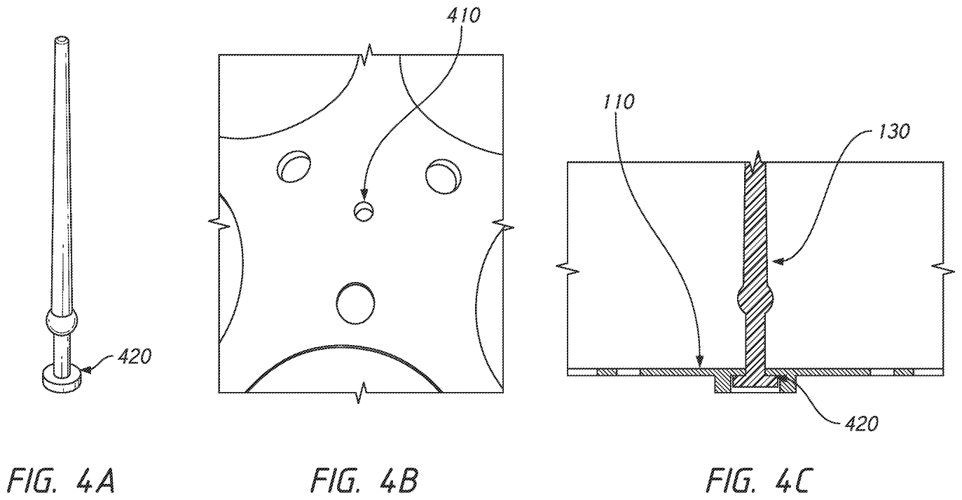

FIG. 4A-FIG. 4C illustrate an exemplary embodiment of a surgical training model 100. In particular, FIG. 4A illustrates an exemplary post 130, FIG. 4B illustrates an exemplary body 110 that includes an opening 410 configured to receive the post 130, and FIG. 4C illustrates an exemplary interface/connection between the post 130 and the body 110 of the surgical training model.

In addition to interacting with the body 110 (e.g., limbs) of the surgical training model 100, in various embodiments, the user is also able to interact with the post 130 of the surgical training model 100 while performing laparoscopic training tasks associated with the surgical training model 100. Exemplary interactions may involve pulling on the post 130 and reorienting the direction the post 130 is extending away from the body 110 (i.e. in an orthogonal or direction that is perpendicular to a plane associated with the body/base).

When the user interacts with (e.g., pulls on) the post 130, a tensile load can be applied to the body 110 via the post 130. The tensile load, when transferred to the body 110, can contribute to the body 110 becoming disengaged/dislodged from one or more components associated with implementing a force perception mechanism 140 for the surgical training model 100 located near the post 130. Details about the post 130 used in various embodiments of the surgical training model 100 will now be described.

In one embodiment, the post 130 may comprise a flexible tubular structure that is configured to extend upward away from the base 120 (i.e. in a direction that is perpendicular from a plane associated with the base 120 of the surgical training model 100). In other embodiments, the post 130 may be more rigid. In various embodiments, the post 130 may have a “stand” or “stopper” 420 located at the bottom of the post 130 (see FIG. 4A).

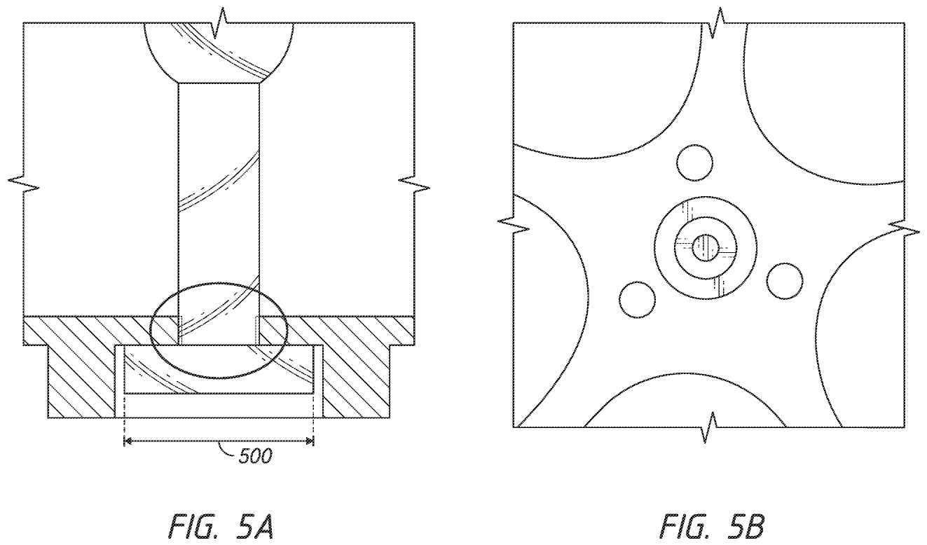

When the post 130 is assembled with the body 110 of the surgical training model 100, the post 130 passes through the body 110 via an opening in the middle of the body 410 (see FIG. 4B). The post 130 can then be pushed through until the stopper 420 contacts the bottom surface of the body 110 (see FIG. 4C). Furthermore, the stopper 420 may be configured to prevent the post 130 from being pulled completely through the opening 420 of the body 110. That is because the stopper 420 may be configured to have a cross-sectional area that is larger than the cross-sectional area of the opening 410 of the body 110. Furthermore, in various embodiments, the post 130 can be connected to (via an interference fit-type connection) or affixed to the body 110 near the opening 410 of the body 110 (see FIG. 5A). In some embodiments, the post 130 is connected/affixed to the body 110 via the use of adhesives (see FIG. 5B). The adhesive connection can allow for the user to exert a greater amount of force on the post 130 without concern that the post 130 will detach from the body 110. In various embodiment, the post 130 can be connected to and/or interface with the base 120 within an indented space 500. The indented space 500 provides an area where adhesive can be applied in order to adhere the post 130 to the body 110. In various embodiments, the indented space also facilitates in force distribution around the center of the body 110 (near the post 130).

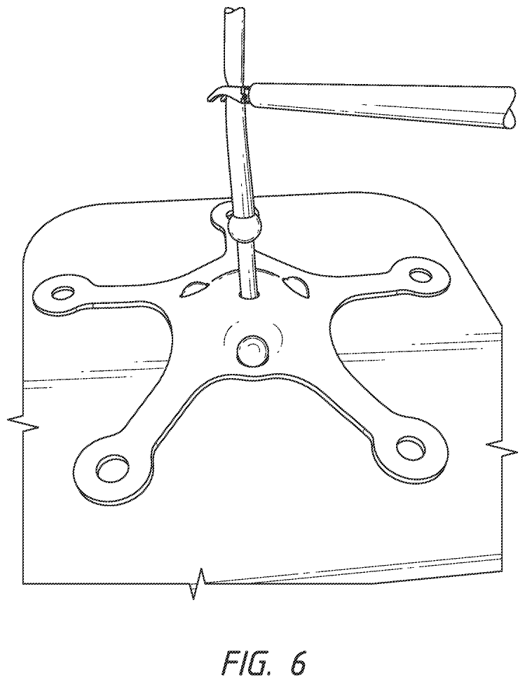

In various embodiments, when the user interacts with the post 130 (e.g., the user pulls on the post 130 with a laparoscopic instrument as illustrated in FIG. 6), some of the tensile load associated with the user interaction with the post 130 can be transferred to the body 110. If the amount of tensile load the user is asserting on the post 130 is excessive, the tensile load can produce a corresponding force on the body 110 (via the connection between the post 130 and the body 110) which can exceed the predetermined force threshold. In this way, the tensile load from the post 130 may cause the body 110 to become detached from one or more components (e.g., pegs) that are associated with the force perception mechanism 140 of the surgical training model 100.

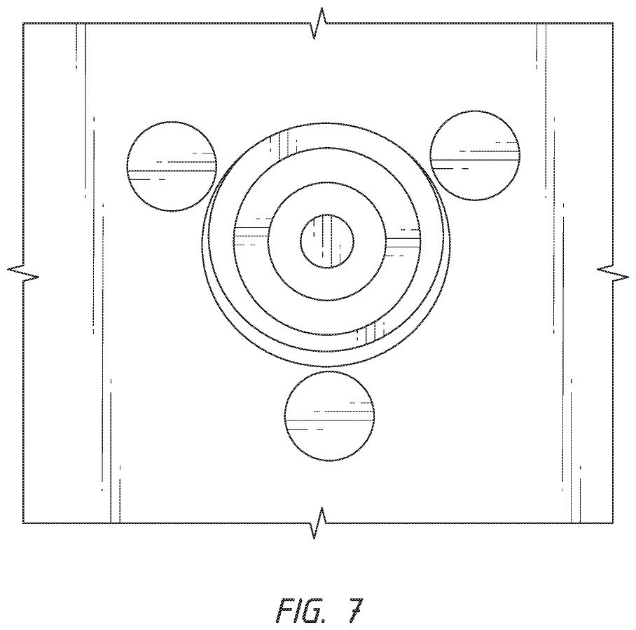

In various embodiments, features can be incorporated to minimize any possible effect that can be caused by contact between the body 110 and the base 120. For example, as illustrated in FIG. 7, the body 110 of the surgical training model 100 may have an open space (or opening) that would allow the pocket for the post 130 in the body 110 to keep from coming into contact with the base 120 thereby minimizing/preventing the base 120 from influencing/affecting the predetermined force threshold between the body 110 and the components.

In various embodiments, the materials which makes up the post 130 can also be used to affect the force threshold in connection with the tensile load being provided to the post 130. For example, if the post 130 is made of an elastic or stretchable material, parts of the post 130 may stretch which can change the force threshold associated with the connection between the post 130 and the body 110 by changing how the force being applied to the post 130 will be transferred. At some point, however, the post 130 may not be capable of being stretched further, which would result in any additional force being applied to the post 130 by the user to now be directly transferred to the body 110 thereby causing the body 110, in some embodiments, to disengage from one or more pegs after having used some of that force to stretch itself.

In contrast, rigid or non-elastic material is more capable of distributing the force being applied to the body 110. As such, in some embodiments, the force being applied to the rigid post 130 would not be absorbed by any stretching of the post 130 which causes all of the force being applied to be transferred to the body 110. As a result, a lower force threshold is present between the body 110 and the pegs in comparison to the use of elastic materials for the post 130.

It should be noted that materials that are extremely elastic or extremely rigid may not be useful in the implementation of the surgical training model 100. For example, extremely rigid materials used for the post 130 and/or body 110 may prevent the post 130 and/or body 110 (e.g., limbs) from flexing to complete laparoscopic training tasks (e.g., threading an opening of a limb with respect to a post at the center of the surgical training model 100). In contrast, an extremely elastic material could minimize the effectiveness of the force perception mechanism 140 being implemented because of the stretchability of the body 110 absorbing a lot of the force being exerted on the body 110 which may affect (e.g., stretch) the openings of the body 110 that interface with the operation of the force perception mechanism 140.

As noted above, based on the material used for the body 110, there may be a “stickiness” between the body 110 and the base 120 of the surgical training model 100 that may affect the function of the force perception mechanism 140 since the force threshold should correspond only to the contact between the body 110 and the components implementing the force perception mechanism 140. To counteract possible stickiness from materials associated with the body 110, in some embodiments, the base 120 may be configured to add “roughness-type” features on the top surface of the base 120 that contacts with the body 110. Other embodiments may add roughness to the bottom surface of the body 110, anti-stick coating on one or both of the body 110 and base 120, and/or introduce additional materials between the body 110 and the base 120 to prevent the “stickiness” between the body 110 and the base 120. In various embodiments, anti-stick coating or layer can also be attached or integrated with one or more of the bases 120 and/or bodies 110 to prevent or reduce “stickiness.” In various embodiments where the surgical training model 100 has a plurality of layered bodies 110, these features can also be used to minimize or prevent adherence or stickiness between adjacent layers of bodies 110 as well.

In the following sections, the present disclosure will describe various embodiments that pertain to different variations of the force perception mechanism implemented with surgical training models. Surgical training models utilizing combination of the different force perception mechanisms described herein are also contemplated.

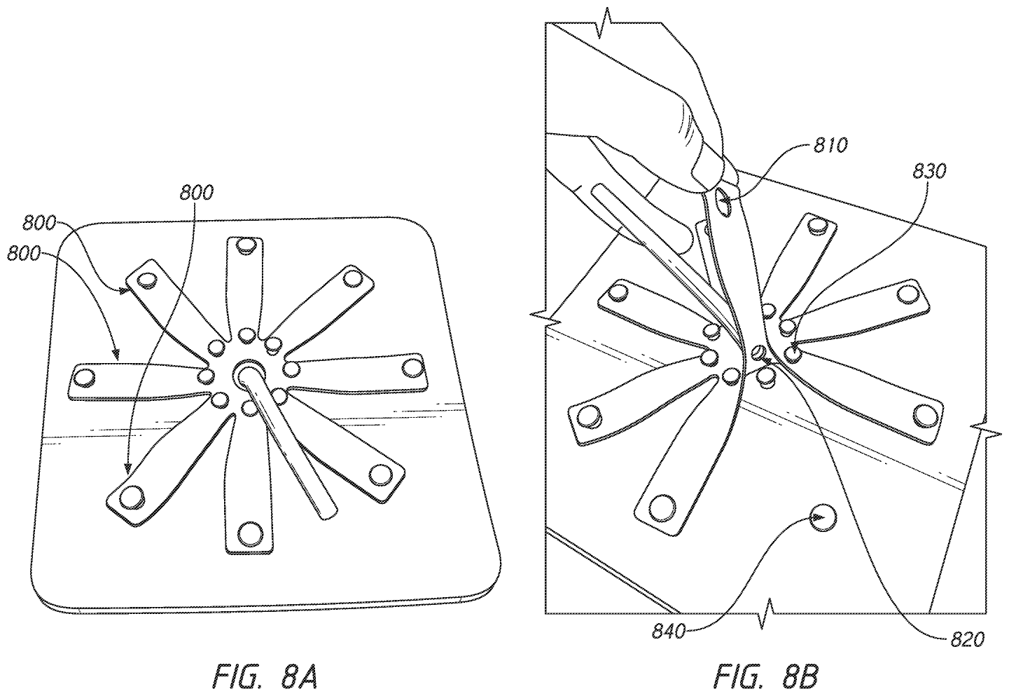

FIG. 8A and FIG. 8B illustrate another embodiment of a surgical training model 100 with a force perception mechanism 140. Similar to the embodiment discussed above in FIG. 1A and FIG. 1B, the embodiment in FIG. 8A and FIG. 8B also comprises a post 130, a body 110 (with one or more limbs 800), and a base 120. Although the limbs 800 associated with the body 110 are all connected, in various embodiments, the limbs 800 (that are extending away from a central point where the post 130 is located) may instead be separate from each other.

With each of the limbs, a pair of openings 810, 820 are located on the limbs 800, for example, one at the distal end 810 of the limb (i.e. furthest away from the post 130) and one at the proximal end 820 of the limb 800 (see FIG. 8B). With each of the limbs 800, a component used for implementing a force perception mechanism 140 (such as a peg 830) may be connected with a proximal opening 820 at the proximal end of the limb 800. On the distal end of each of the limbs 800, a separate structure, e.g., a rod 840, may be connected to the distal opening 810 that is configured to keep the limb attached to the base 120 until the user decides to interact with that particular limb 800 (in which case the user can remove the limb 800 from the structure 840).

With the illustrated surgical training model 100, in various embodiments, users may be directed to perform a laparoscopic training task whereby the user would first need to remove the limb 800 from the rod 840 located at the distal end of the limb 800 using one laparoscopic device. Once the distal end of the limb 800 is removed from the rod 840, the user can maneuver to the post 130 through the now unoccupied opening in the distal end 810 of the limb 800. The user would control/maneuver the post 130 with a second laparoscopic device. Using the two laparoscopic devices, the user would maneuver one or both (the post 130 and/or the limb 800) in order to thread the post 130 through the opening at the distal end 810 of the limb 800.

As the user performs the above laparoscopic training task, the user is directed to avoid applying excessive force to the limb 800 and the post 130 because excessive force to one or both would cause the limb 800 (as well as potentially other limbs) from disengaging from one or more pegs 830. In various embodiments, the excessive force may cause only the peg 830 associated with and/or closest to the limb 800 being manipulated to become disengaged from the body 110. In various embodiments, the excessive force can cause one or more pegs 830 associated with and/or proximate to one or more of the other limbs 800 to become disengaged from the body 110.

In various embodiments, the size of the pegs 830 (especially the ones located near the post 130 at the proximal end of the limbs 800) can be impacted by the distance they are positioned away from the post 130. In particular, as the pegs 830 are closer to the post 130, the diameter/size of the pegs 830 may need to be designed to be smaller in order to provide enough clearance (between the peg 830 and the post 130 and between each other) so that users can interact (e.g., grab) the peg 830 and/or the post 130 as needed. However, the smaller peg diameter may prove difficult for users to interact with the peg 830 (via the proximal opening 820 of the limb 800) given the size of various laparoscopic devices (e.g., graspers) in use.

In various embodiments, by providing separate components for implementing a force perception mechanism 140 for different portions of the surgical training model 100, training can be simplified. For example, various embodiments can allow the user to train and become accustomed with asserting force to a specific portion (e.g., one limb 800 or the central post 130) without needing to be cognizant of how force being applied to one portion of the surgical training model 100 could unintentionally affect other portions of the surgical training model 100. This allows users the ability to focus on performing a laparoscopic training task for a particular portion of the surgical training model 100. As in the embodiments of FIG. 8A and FIG. 8B, the limbs 800 and/or the pegs 830 can be configured, in various embodiments, so that force applied to one of the limbs 800 will not affect other limbs 800 and associated pegs 830. Furthermore, other embodiments may be possible where force perception mechanisms 140 can be associated with the post 130 and would not be affected by force applied to one or more of the limbs 800.

In various embodiments, components (e.g., pegs 830) associated with one part of the surgical training model 100 can be configured to be affected when forces are applied to other parts of the surgical training model 100. This can be used to complicate (i.e., make harder) the laparoscopic training task. Furthermore, such embodiments may be more representative of forces being applied to tissue in an actual surgical procedure where actions in one part of the patient's body do have consequences with other portions of the patient's body.

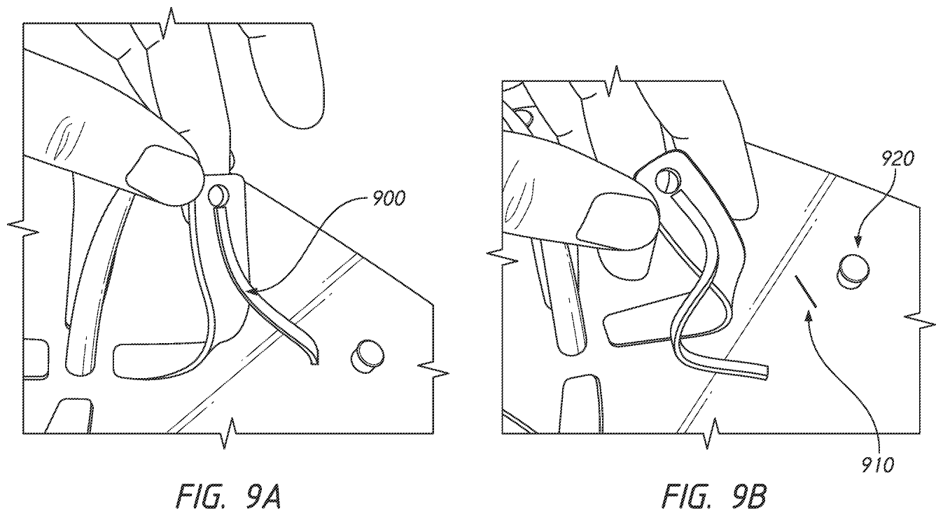

FIG. 9A and FIG. 9B illustrate another example embodiment of a surgical training model 100 with a force perception mechanism 140. In particular, the force perception mechanism 140 may utilize a tether 900.

As illustrated in FIG. 9A, the exemplary force perception mechanism 140 has a tether 900 that is affixed at one end to an underside of the body 110 (e.g., limb). The tether 900 may be affixed to the limb, for example, via the use of an adhesive. Meanwhile, the opposite end of the tether is removably coupled to the base 120. In various embodiments the removable connection between the tether 900 and the base 120 is created by having a slot 910 in the base 120 in which the tether 900 is inserted therethrough. Thus, the slot 910 in the base 120 will generally have a cross-section (e.g., height and width) that is smaller than that of the cross-section of the tether 900 in order to provide for the interference-type connection and therefore the specific friction force. In doing so, the tether 900 provides the ability for the surgical training model 100 to detect when an excessive amount of force is present when the tether 900 becomes detached from the base 120.

In various embodiments, a predetermined force threshold for the force perception mechanism 140 implemented using the tether 900 can be adjusted based on various factors. For example, the pre-determined force threshold can be changed by adjusting the total length of the tether 900 that would be inserted through the slot 910 in the base 120. In an embodiment, the tether 900 can be made to be long which would require the user to exert more force over a longer period of time before the tether 900 can become detached from the base 120 compared to another embodiment where the tether 900 is shorter. In addition, the type of materials and surfaces in contact between the tether 900 and the base 120 which may determine how much friction is present between the tether 900 and the base 120 as well as how much the tether 900 can stretch before detaching from the base 120. For example, a “stickiness” can add additional resistance that would increase the amount of required force to move and cause the tether 900 to become detached from the base 120. As noted above, the dimensions/cross-sectional area of the tether 900 and the slot 910 can also be changed to influence the interference-type connection between the two. The smaller the cross-sectional area of the slot 910 is compared to that of the tether 900, the tighter the fit between the two which creates a greater amount of friction that would prevent forces from detaching the tether 900 from the base 120.

With reference back to FIG. 9A, in some embodiments, when the limb is resting on the base 120 (i.e. the surgical training model 100 is in its initial first state), the tether 900 may be resting between the base 120 and the limb. If the tether 900 has dimensions smaller than the body 110 (e.g., limb), in some embodiments, the tether 900 may be at least partially hidden beneath the limb.

In various embodiments, the base 120 may have additional structures that are configured to interface/connect with the limb (see FIG. 9A). For example, the limb may have an opening that is configured to interface with a rod 920. In some embodiments, the rod 920 may be used to hold the limb in a stationary position until operated on by removing the limb from the rod 920.

In various embodiments, the tether 900 (much like the pegs described above) is configured to act as a visual indicator of when an excessive amount of force has been exerted on the limb. In particular, the visual indicator indicating that excessive force has been detected corresponds to when the tether 900 becomes detached from the base 120. An example scenario where the tether 900 indicates that an excessive amount of force has been detected can be seen as illustrated in FIG. 9B where it is shown that the tether 900 is detached from the slot 910 in the base 920. The detachment of the tether 900 can be used as an indication that an excessive amount of force has been applied to the surgical training model 100 that could have caused trauma to tissue during a real surgical procedure. When the tether 900 becomes detached from the base 120, the detachment causes the surgical training model 100 to transform from an initial state (where the tether 900 is attached to the body 110 and the base 120) to a transformed state (where a portion of tether 900 has been detached from the base 120). As noted above, the predetermined force threshold associated with the tether 900 can be customized thereby affecting how much force a user may be able to exert on the limb prior to the tether 900 being detached from the base 120.

To utilize the surgical training model 100 for further training after the completion of a laparoscopic training task, the user may be directed to reset the surgical training model 100 back to its initial state. The resetting of the surgical training model 100 can be performed by having the user re-attach the tether 900 to the base 120 (by inserting the tether 900 into the slot 910) so that the tether 900 is connected to both the base 120 and the limb of the surgical training model 100.

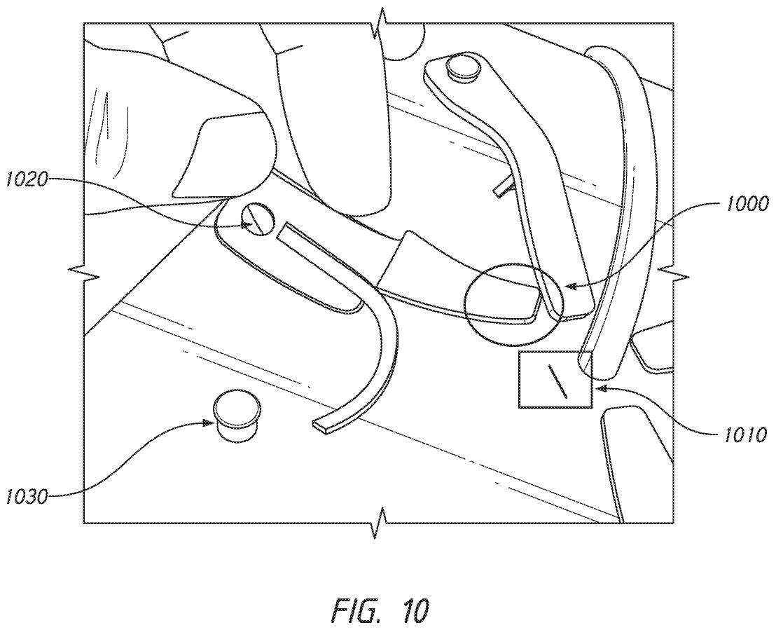

FIG. 10 illustrates another example embodiment of a surgical training model 100 having a force perception mechanism 140 implemented therein. In this embodiment, the surgical training model 100 comprises a number of independent limbs 1000 which are not connected to each other nor to the post 130 located at the center of the surgical training model 100. Rather, the end of the body 110 (e.g., limb 1000) closest to the post 130 may be removably connected to the base 120 via a slot-shaped opening 1010.

The slot-shaped openings 1010 are provided so that the proximal end of the limb 1000 (portion of the limb closest to the post 130) is able to be inserted therethrough to provide for a removable connection (e.g., interference fit connection) between the base 120 and the limb 1000. The connection between the proximal end of the limb 1000 and the base 120 provides the surgical training model 100 with the force perception mechanism 140 that is used to identify when an excessive force is detected corresponding to when the limb 1000 is detached from the base 120. If during the performance of a simulated surgical task, the user exerts an excessive amount of force on the limb 1000, this may cause the end of the limb 1000 removably connected to the base 120 to become detached from the base 120. The detachment of the limb 1000 from the base acts as a notification that an excessive force was detected and would correspond to a situation where the excessive force could have caused trauma to tissue during an actual surgical procedure.

In various embodiments, the force threshold can be modified in a similar manner as the tethers 900 described above. For example, by having the cross-sectional area of the body 110 (e.g., limb 1000) be larger than that of the slot-shaped opening 1010 in the base 120, this would provide for more friction between the body 110 and the base 120. Materials used for the limb 1000 and/or base 120 can add features (e.g., stickiness, roughness) that also affect the friction between the body 110 and the base 120 that would increase the amount of force needed to detach the limb 1000 from the base 120. The material choice for the limb 1000 would also affect how much the limb 1000 can stretch before detaching, also affecting the force threshold. In addition, the length of the limb 1000 being connected through the base 120 (via the slot-shaped opening 1010) also influences the force threshold by affecting how much force and for how long the force would need to be applied before the limb 1000 can be detached from the base 120.

Much like the embodiment described in connection with FIG. 9A and FIG. 9B, the distal end of the limb 1000 may also have an opening 1020 which is configured to connect to a structure 1030 (e.g., rod). The rod 1030 can be used to maintain the limb 1000 in an initial rest state while not being operated on during a laparoscopic training task whereby the user would cause the limb 1000 to become disengaged from the rod 1030 before.

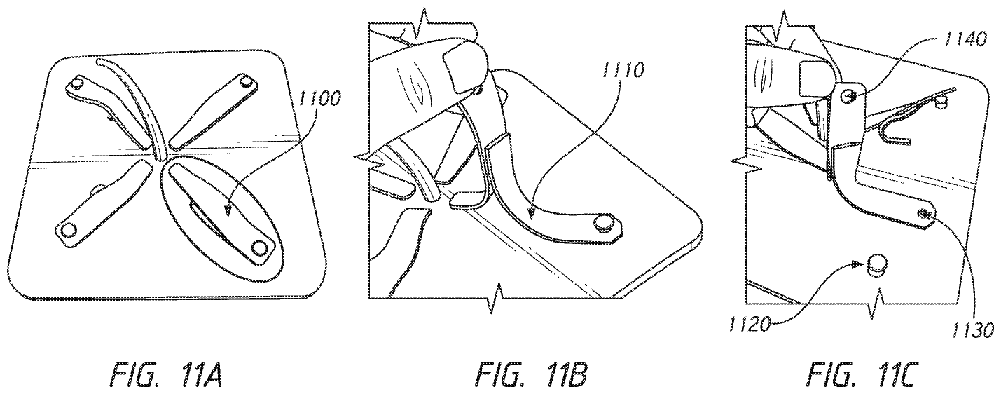

FIG. 11A-FIG. 11C illustrate another embodiment of a surgical training model 100 implementing a force perception mechanism 140. In this embodiment, the force perception mechanism 140 comprises a combination of a tether 1110 and a peg 1120. As seen in FIG. 11B, the tether is adhered to an underside of the body 110 (e.g., limb 1100) at one end and is connected (via an opening 1130 in the tether 1110) to the peg 1120 attached to the base 120. In some embodiments, the limb 1100 may also have an opening 1140 at the distal end (e.g., end furthest away from the post 130) that is also configured to connect with the same peg 1120 on top of the tether 1110. The opening 1140 in the limb 1100 can provide a way for the limb 1100 to be held in place with the peg 1120 until used.

With reference to the force perception mechanism 140, each of the limbs 1100 may utilize the combination of the tether 1110 and the peg 1120 to detect when an excessive amount of force has been exerted on the limb 1100. As illustrated in the figures, one end of the tether 1110 is attached (e.g., via adhesives or built as a monolithic structure) to the limb 1100 on one end. The other end of the tether 1110 has an opening 1130 that is configured to be removably connected to the peg 1120 that is attached to the base 120.

In an initial first state, as seen in FIG. 11A, the force perception mechanism 140 (e.g., the combination of the tether 1110 and the peg 1120) will partially be hidden by the limb 1100. For example, the tether 1110 portion of the force perception mechanism 140 may bend/fold beneath the limb 1100. Meanwhile, the peg 1120 portion of the force perception mechanism 140 will be removably connected with the tether 1110 but will be hidden/obscured by the connection between the peg 1120 and the limb 1100 on top.

FIG. 11B illustrates an embodiment where the user may be interacting with the limb 1100 and the associated force perception mechanism 140. While in an intermediate state, the user causes the limb 1100 to become detached from the peg 1120 thereby allowing movement of the limb 1100 for the laparoscopic training task (e.g., maneuvering the opening of the limb to thread a post). As illustrated in the figure, the tether 1110 is attached to the underside of the limb 1100. In various embodiments, the tether 1110 may be connected at different points along the length of the limb 1100 (e.g., connected at the middle of the limb 1100). The difference in where the tether 1110 is attached to the limb 1100 may be used to affect how easily the other end of the tether 1110 is disengaged from the peg 1120 thereby affecting the force threshold associated with the force perception mechanism 140 being implemented with the limb 1100.

FIG. 11C illustrates the scenario whereby the force perception mechanism 140 is indicating that an excessive amount of force has been detected with the limb 1100. In particular, the figure shows that the tether 1100 has become detached from the peg 1120. In this situation, the force perception mechanism 140 is able to notify the user that the laparoscopic training task involving that limb 1100 has failed due to the user exerting too much force.

In various embodiments, the act of the tether 1100 detaching from the peg 1120 may act as a notification indicating to the user that an excessive amount of force has been detected with the limb 1100. In other embodiments, the act of detaching the tether 1110 may be capable of transforming/transition the overall surgical training model 100 (or at least the portion associated with the force perception mechanism 140) to a transformed state. In the transformed state, the surgical training model 100 can be rendered non-functional. In other words, the user may not be capable of further continuing the laparoscopic training task with that specific limb 1100 unless the surgical training model 100 is reset back to its initial first state (as illustrated in FIG. 11A). Resetting the surgical training model 100 is made easy with inserting the opening 1140 of the limb 1100 and the tether 1110 back onto the peg 1120.

Similar to various embodiments discussed above, the connection between the limb 1100 and/or the tether 1110 and the peg 1120 can be configured to provide a different force threshold based on the amount of friction between the tether 1110 and the peg 1120. In various embodiments, the limb 1100 and/or the tether 1110 can be configured to have different force thresholds with the peg 1120. Changes to the diameter and/or cross-sectional area of the opening 1140 of the tether 1110 and/or changes to the cross-sectional area of the peg 1120 can be used to customize the amount of friction present between the tether 1110 with the peg 1120 and thus the force threshold for the force perception mechanism 140. In addition, the type of material in which the limb 1100 and/or tether 1110 is made of can also affect the amount of friction between the tether 1110 and the peg 1120 as well as their stretchability; thereby affecting the force threshold of the force perception mechanism 140 illustrated in the figure.

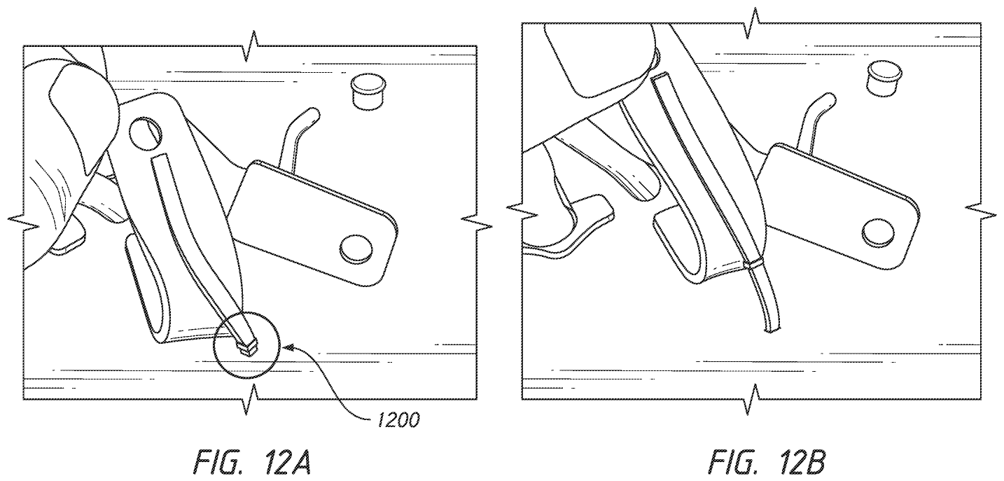

FIG. 12A and FIG. 12B illustrate another embodiment of a surgical training model 100 implementing a force perception mechanism 140. As illustrated in the figures, the force perception mechanism 140 is implemented using a tether that is attached (e.g., via adhesives or casted as a single structure) at one end to the body 110 (e.g., limb) but the other end is passed through the opening in the base, and in various embodiments, can extend some distance beneath the base.

In an embodiment, the tether used for the force perception mechanism 140 may be long enough to be slack (above and/or below the base 120) when the surgical training model 100 is in an initial first state at the start of a laparoscopic training task. An indicator 1200 is present at a pre-determined location along the length of the tether. For example, the indicator 1200 may be located where the tether meets the base as seen in FIG. 12A during the initial first state. In some embodiments, the indicator 1200 may be located beneath the base 120 and thus hidden from the user during the initial first state.

The initial location of the indicator 1200 during the initial first state is used as a visual guide corresponding to an amount of force being applied to the surgical training model 100 (e.g., to the independent limb attached to the tether in question). By viewing a distance that the indicator 1200 travels from the initial location (for example at/near the base 120 as seen in FIG. 12B), the user can determine whether excessive force has been applied to the surgical training model 100. If the indicator 1200 is initially hidden from the user, the reveal of the indicator 1200 above the base can be used as an indication that excessive force has been applied to the surgical training model 100.

In various embodiments, the indicator 1200 may be a visual mark on the tether. In other embodiments, physical structures such as a ring, disk, or other structure can be attached to the tether 1200 and used as a visual marker to gauge an amount of force being exerted on the limb based on the distance the physical structure travels from the initial location near the base 120. In some embodiments, a combination of a visual mark and physical structures can be used.

In some embodiments, the tether is made of an elastic material. As such, forces applied to the tether via the limb may cause the tether to stretch. The elastic tether may be secured at the base 120 so that when the tether is stretched, the indicator 1200 may be moved from its initial location to a different location (e.g., at/near the base to away/distal from the base 120 or hidden beneath the base to a position above the base 120).

In other embodiments, the tether may not be stretchable or anchored. As force is applied to the tether, portions of the tether beneath the base 120 may be pulled through the opening in the base 120 such that additional portions of the tether are pulled above the base 120. As more of the tether is pulled above the base, the indicator 1200 will be moved from its initial location (e.g., at/near the base 120) to a position away or distal from the base 120. In various embodiments, the tether may include a ring or stopper at some point along the tether beneath the base 120 in order to prevent the tether from being completely pulled above or out of the base 120.

The indicator 1200 is used to determine if an excessive amount of force was detected. In some embodiments, any movement of the indicator 1200 can be used to notify that an excessive amount of force was detected. In some embodiments, if the indicator 1200 remains within a pre-determined amount of distance from the base 120, this can be identified as being an appropriate amount of force being applied to the surgical training model 100. As such, the tether for the force perception mechanism 140 can be customized based on the location of where the indicator 1200 is located on the tether, how far the indicator 1200 is allowed to travel from the base 120, as well as the elasticity of the tether, or any combination thereof.

Based on the type of tether being used for the force perception mechanism 140, the user may or may not be required to manually reset the surgical training model 100 back to the initial state when the indicator 1200 is moved from its initial location at/near the base 120. In the embodiments where the tether is elastic, the elastic tether may be configured to return back to its non-stretched state upon lessening/ending the force being applied to the surgical training model 100. In returning back to the non-stretched state, the indicator 1200 on the tether should return back to the initial location. If the embodiment of the tether is less elastic and the indicator 1200 is moved away from the base 120 because additional portions of the tether are pulled from beneath the base 120, the user may be directed to pull the tether back below the base 120 such that the indicator 1200 is at the initial location.

In some embodiments, the tether being used for implementing the force perception mechanism 140 may be part elastic and part non-elastic. In particular, a portion of the tether above the indicator 1200 may be made non-elastic such that any force applied to the tether will not cause the portion of the tether above the indicator 1200 to stretch. However, a portion of the tether below the indicator 1200 (which is secured to the base 120) may be elastic. When force is applied to this embodiment of the force perception mechanism 140, the elastic portion below the indicator 1200 will stretch due to the applied force and the indicator 1200 will move away from the base 120. When the force is lessened/removed from this embodiment of the force perception mechanism 140, the elastic portion of the tether can be biased to return back to its non-stretched form which in turn causes the indicator 1200 to return back to its initial location/state. Thus, resetting of the surgical training model 100 can be performed automatically for these embodiments.

It should be noted that other embodiments can use other features other than an indicator 1200 as described above as a visual guide to identify when excessive force has been detected with the surgical training model 100. For example, instead of a marking used as the indicator 1200, other embodiments may use a physical structure such as a ring that can be attached to the tether. In other embodiments, the tether may have protrusions whereby the tether at specific locations have a cross-sectional area that is larger than the cross-sectional area of nearby or adjacent sections of the tether. In these embodiments, the physical structure or protrusions are capable of also allowing the user to visualize how much force is being applied to the limb based on how far the physical structure or protrusion are pulled away from the initial location/state. In addition, in various embodiments, the physical structure or protrusion allow for the resetting of the surgical training model 100 back to its initial first state (upon the lessening or removal of the applied force on the tether) as the tether returns back to its non-stretched form as the physical structure or protrusion can be configured to rest above base 120 during the initial first state. In some embodiments, the physical structure or protrusion can be configured to have a cross-sectional area that is larger than the cross-sectional area of the opening in the base 120 thereby preventing the physical structure or protrusion from passing through the base 120 as the tether returns back to the initial first state. In another embodiment, additional markings can be provided on the portions of the tether below the base 120. The additional markings can be color coded to reflect varying amounts of force being applied on the limb that would cause the tether to be pulled up or stretched above the base 120. The colors can be used to quantify whether an amount of force is allowable or not. For example, if a green marking is shown, this can be indicative that the force being exerted is currently acceptable. However, if a red marking is shown, this can be indicative that an excessive amount of force was detected.

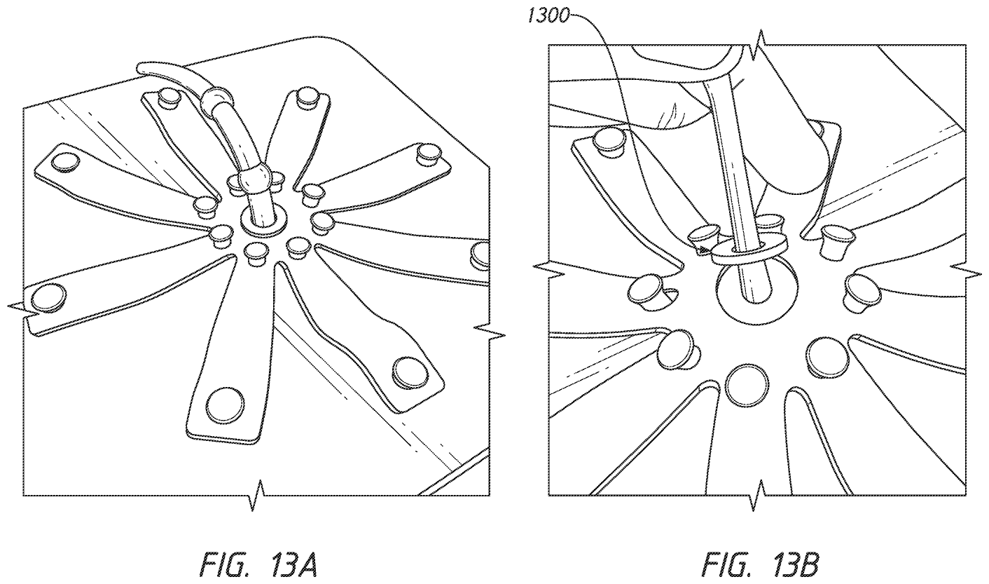

FIG. 13A and FIG. 13B illustrate another embodiment of a surgical training model 100 implementing a force perception mechanism 140. In this embodiment, a force perception mechanism 140 is particularly associated with the post 130 of the surgical training model 100. In particular, a physical structure 1300 such as a ring or washer can be used as an indicator and is affixed at a pre-determined position on the post 130. While in an initial first state, the physical structure 1300 may be located near/at the base of the surgical training model 100 (see FIG. 13A). The physical structure 1300 will be used as a visual indication regarding when excessive amounts of force are applied to the post. When force is applied to the post 130, the post 130 may be stretchable which would cause the indicator to move away from the location near or at the base 120 as the post 130 becomes stretched due to the applied force.

In various embodiments, the post 130 may be secured to the base 120. As forces are applied to the post 130 (e.g., the post 130 is pulled), the post 130 (based, in part, on the elasticity of the material making up the stretchable post 130) will stretch. With the position of the physical structure 1300 being fixed on the post, the physical structure 1300 will be moved in a position relative to the base (e.g., away from the base 120) (See FIG. 13B) as the post stretches. This change in position and the corresponding distance from the base 120 for the physical structure 1300 can be used to determine whether an excessive amount of force has been applied to the post 130; namely if the physical structure 1300 exceeds a pre-determined distance from the base 120, this condition could deem that an excessive amount of force was detected. In some embodiments, the physical structure 1300 can signify that the laparoscopic training task was a failure since the excessive amount of force (if applied during an actual surgical procedure) may cause trauma to tissue being operated on.

To reset the surgical training model 100, the post 130 (being at least partly elastic) can be configured to return to its initial first state automatically upon user release of the force being applied to the post. This allows the indicator to return to the predetermined position at or near the body 110 and/or base 120.

It should be noted that other embodiments can use different features other than the physical structure 1300 described above. For example, instead of the ring, a visual marking (similar to that described in FIG. 12A and FIG. 12B) can be used with the post 130. For example, a marking on the post 130 can be used to visually identify how much force was being exerted on the post 130 based on how far the marking is moved away from the base 120 and/or the body 110.

In various embodiments, to reset the embodiment of the surgical training model 100 in FIG. 13A and FIG. 13B, the post may be configured to be biased back to the initial first state upon lessening or removal of the force being applied to the post. This allows the post to revert back from a stretched state (when force is applied to the post) to a relaxed state (corresponding to the initial first state). In the relaxed (or unstretched state), the indicator may be configured to be positioned at/near the body 110 and/or base.

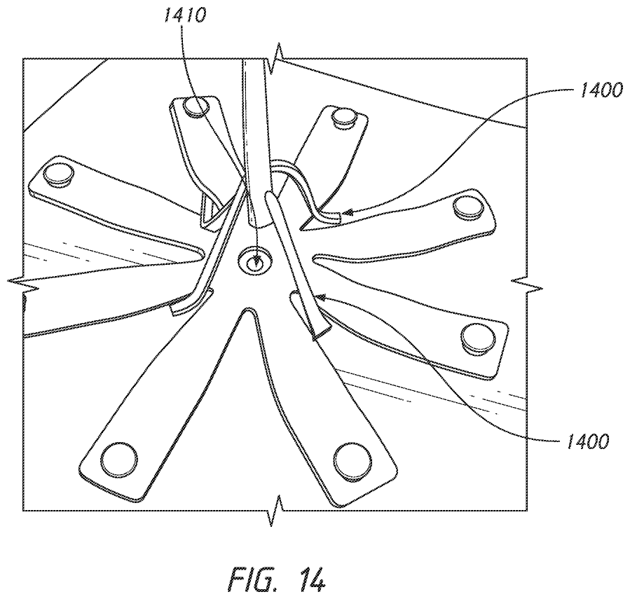

FIG. 14 illustrates another embodiment of a surgical training model 100 implementing a force perception mechanism 140. In particular, the force perception mechanism 140 comprises a post 130 that is removably connected to the base 120 and/or body 110 and a plurality of strips 1400 that are connected with both the post 130 and the base 120. In various embodiments, the strips 1400 may be manufactured (e.g., injection molded) as a single piece with the post 130 and connected to the base 120 and/or body 110.

In various embodiments, the post 130 is configured to be inserted into an opening 1410 located in the base 120, body 110, or both. The post 130 may be removably connected to the base 120, body 110, or both via the opening 1410 (e.g., interference fit). If an excessive amount of force is applied to the post 130 (e.g., the user pulls on the post 130 via laparoscopic instruments), the post 130 can become disengaged from the base 120, the body 110, or both as illustrated in FIG. 14. The disengagement of the post 130 from the body 110, base 120, and/or both can be used as an indicator that excessive force has been detected corresponding to potential trauma in tissue being operated on during an actual surgical procedure. The plurality of strips 1400 is provided in order to secure the post 130 to the surgical training model 100 for the times when the post 130 becomes detached from the base 120, the body 110, or both. In some embodiments, the strips 1400 may be excluded from the implemented force perception mechanism 140.

In various embodiments, the pre-determined force threshold associated with the post 130 can be customized. Factors such as changing the cross-sectional area or diameter of the openings 1410 of the base 120 and/or body 110, the cross-sectional area or diameter of the post 130, the materials making up the base 120, body 110, and/or post 130, and the degree of elasticity of the post 130 can all influence how much force may be used before the post 130 becomes detached from the base 120 and/or the body 110. For example, the materials making up the post 130 and the body 110 and/or base 120 can impact the amount of friction present as the post 130 is being detached from the body 110 and/or base 120 while connected via an interference fit connection. Furthermore, in embodiments where the post 130 is elastic, a force exerted on the post 130 can be distributed along the length of the post 130 as the post 130 stretches. The distribution of force along the length of the removable post 130 due to the stretchable characteristic can reduce an amount of force that is transferred to the end of the post 130 connected to the base 120 and/or body 110 which in turn increases the force threshold associated with the force perception mechanism 140 being implemented in the surgical training

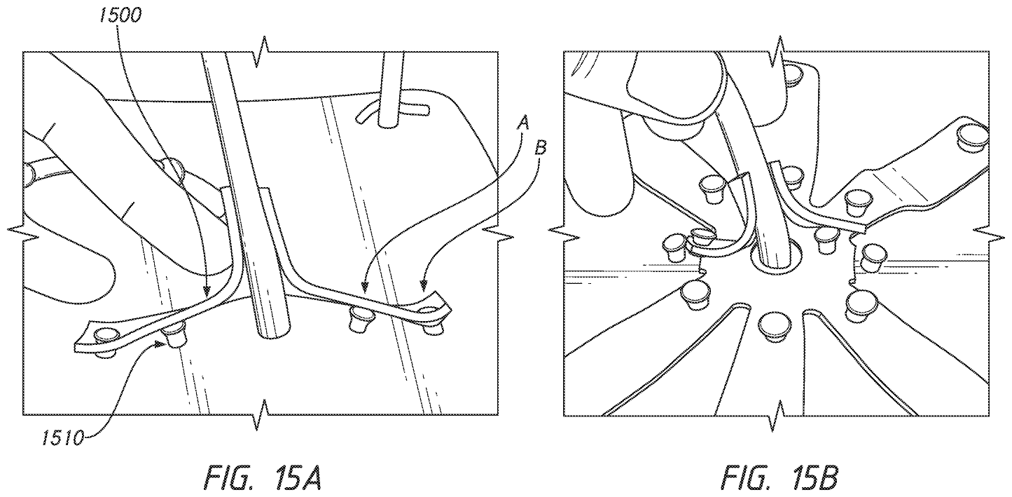

FIG. 15A and FIG. 15B illustrate additional embodiments of a surgical training model 100 with a force perception mechanism 140. In these embodiments, the force perception mechanism 140 is again associated with the post 130. As illustrated in FIG. 15A, an embodiment of the force perception mechanism 140 may use one or more flaps 1500 that are attached to the post 130 at one end. The other end of the flaps 1500 has one opening (not shown) which is adapted to removably connect with a peg 1510 attached to the base 120.

In various embodiments, the base 120 may have two or more pegs 1510. The pegs 1510 may be grouped (A or B as seen in FIG. 15A) based on a distance away from the post 130. For example, a first set of pegs closest to the post (e.g., A) may each be the same distance away from the post 130 while a second set of pegs (e.g., B) are similarly the same distance farther away from the post 130 compared to the first set of pegs. The opening for the flaps 1500 is configured to connect with one of the pegs 1510. With there being different sets of pegs 1510 where one set (e.g., A) may be closer than others (e.g., B), different force thresholds can be provided for force perception mechanism 140 associated with the post 130. Specifically, the difference in distance between the first set of pegs (A) and the second set of pegs (B) provide different force thresholds for the flaps 1500 based on the extent that the flap 1500 needs to stretch in order to align its opening with a corresponding peg 1510.

As illustrated in embodiments in FIG. 15A and FIG. 15B, two flaps 1500 may be attached to the post 130 on opposite sides (i.e., 180 degrees offset from each other). With each of the flaps 1500, a corresponding set of pegs 1510 are provided. In various embodiments, more than two flaps 1500 may be used with a corresponding set of pegs 1510. In various embodiments, different numbers of flaps 1500 (e.g., three or more) as well as different orientations for the flaps 1500 (e.g., offset by 90 degrees) with respect to the post 130 are contemplated.

With FIG. 15B, the force perception mechanism 140 is implemented with the flaps 1500 being attached to one of the pegs 1510 that are affixed to the body 110 and/or the base 120. The opening of the flaps 1500 is configured to engage with one of the pegs 1510. When the user exerts force on the post 130 (e.g., pulls the post using one or more laparoscopic instruments), the flaps 1500 may become detached from one or more of the pegs 1510 thereby indicating an excessive amount of force has been detected.

As illustrated in FIG. 15A, each of the flaps 1500 can engage with at least two different pegs 1510; one peg 1510 that is closer (A) and one peg 1510 that is farther (B). Based on which peg 1510 (e.g., closer (A) or farther (B)) the flaps 1500 are connected to, a different force threshold will be associated with that flap 1500. In particular, when the flap 1500 is connected to the closer peg (A), the flap 1500 may have more slack compared to when the flap 1500 is connected to the farther peg (B). The additional slack allows for more force to be exerted before the excess force causes the flap 1500 to stretch and become disengaged with the connected peg 1510.

The connection between the flaps 1500 and the pegs 1510 can be used as an indicator regarding whether an excessive amount of force is being applied to the post 130. In some embodiments, a laparoscopic training task may instruct a user to perform a surgical procedure involving the post 130 without causing one or more of the flaps 1500 to detach from any of their associated pegs 1510. In other embodiments, the flaps 1500 may be allowed to become detached from a pre-determined number or pre-determined set of pegs 1510 before indicating that an excessive amount of force was detected.

In various embodiments, the surgical training model 100 can be configured to become inoperable if the detachment of the flaps 1500 from one or more pegs 1510 occurs (corresponding to a transformation of the surgical training model 100 from an initial first state to a second transformed state). However, the surgical training model 100 is capable of being reset back to the initial first state by having the flaps 1500 be reconnected with their respective pegs 1510.

In the embodiments where there are different groups of pegs 1510 (e.g., a group that is closer to the post 130 and a group that is farther away from the post 130), the laparoscopic training task can utilize these different groupings to create different levels of difficulty. For example, the pegs 1510 that are farther away from the post 130 may be associated with the flaps 1500 that are already experiencing some tensions (i.e. be in a stretched-state) thereby requiring less force before the flaps become dislodged from the pegs 1510 farther away from the post 130. In contrast, the flaps 1500 associated with the pegs 1510 that are closer to the post 130 may have some slack. The slack associated with the flaps 1500 translates to a lesser amount of tension thereby allowing more force to be absorbed (via stretching of the flap 1500) before the flaps 1500 are dislodged from the pegs 1510 that are closer to the post 130. By relying on different tensions on the flaps 1500, surgical training models can have different amounts of forces that are required to dislodge the flap 1500 from the pegs 1510. In this way, the surgical training model 100 can encourage a finer or more coarse force perception skill depending on whether a smaller force or larger force is required from the user to dislodge the flap 1500 from the force perception mechanism 140 implemented peg 1510 during the course of a laparoscopic training task, therefore, allowing for progressive learning. In various embodiments, a laparoscopic training task can be made harder by requiring that none of the pegs 1510 from either group be dislodged from their respective flaps 1500 while an easier difficulty may allow a pre-determined number or subset of pegs 1510 to be dislodged.

In various embodiments, the flaps 1500 may be manufactured separate from the post 130. As illustrated in the figures, the flaps 1500 can be adhered to the post 130 via, for example, adhesives. However, in other embodiments, the post 130 and flaps 1500 may be manufactured as one monolithic structure.

Although the embodiments described above in connection with FIG. 15A and FIG. 15B pertain to a flap 1500 with one opening and two sets of pegs 1510, other embodiments having more than three sets of pegs 1510 or more than one opening are possible and have been contemplated. The use of additional sets of pegs 1510 that are further from the post 130 provide additional difficulty progressions with the flaps 1500 having more or less tension thereby allowing the tuning of the force threshold for an easier or harder simulation. The additional openings in the flaps 1500 could also provide difficulty progression capabilities as well. By having multiple openings be removably connected to multiple pegs 1510, an exercise could allow users to dislodge a pre-determined number of openings (e.g., less than all) before determining that a use of force has become excessive.

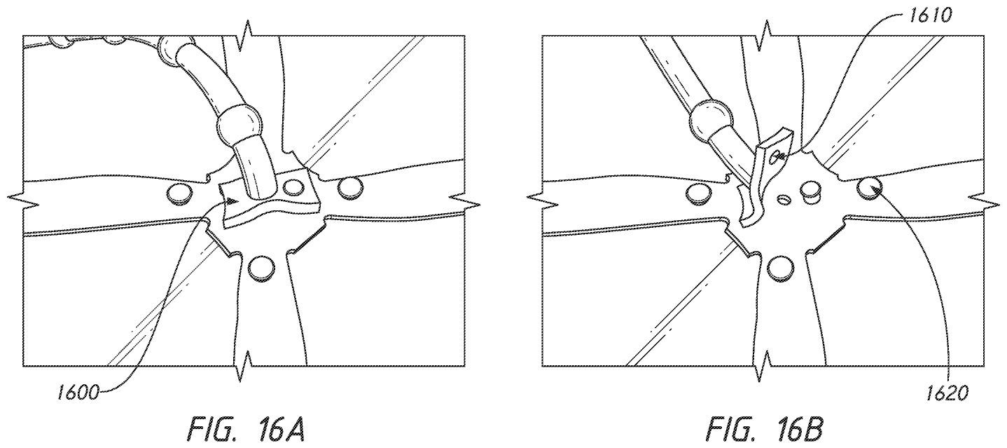

FIG. 16A and FIG. 16B illustrate another embodiment of a surgical training model 100 implementing a force perception mechanism 140. In this embodiment, the force perception mechanism 140 comprises a post 130 that is attached to the body 110 via an attachment or platform 1600 at the bottom of the post 130. One end of the platform 1600 is fixed to the body 110 (e.g., via an adhesive). The other end of the platform 1600 has an opening 1610 that is configured to removably connect (via an interference-type fit) with a peg 1620 that is attached to the body 110. When an excessive amount of force is applied to the post 130 (e.g., via pulling of the post 130), the platform may become detached from the peg. In various embodiments, the force perception mechanism 140 can also have the post 130 be attached in a similar manner directly to the base 120 or at least partially attached to the body 110 and the base 120.

In various embodiments, the platform 1600 at the bottom of the post 130 may be a planar structure that is manufactured with the post 130 as a single monolithic structure (as illustrated in FIG. 16A and FIG. 16B). The platform 1600 may have an opening 1610 on one side that is configured to interface with a peg 1620 located on the body 110. In various embodiments, the platform 1600 may be manufactured and created separate from the post 130 and subsequently attached to the post 130 (e.g., via adhesives). In various embodiments, the peg 1620 may also be located on the base 120.

As noted above, if the user ends up applying an excessive force (e.g., pulling the post 130 in a particular direction such as away from the body 110), the excessive force may cause portions of the post 130 (i.e. the attachment via the platform 1600) to disengage from the peg 1620. In some embodiments, the attachment of the post 130 disengaging from the peg 1620 can render the surgical training model 100 inoperable (i.e. progressing the surgical training model 100 from an initial first state to a transformed state). Furthermore, the attachment of the post 130 disengaging from the peg 1620 can also be used to notify that an excessive amount of force has been detected (see FIG. 16B) during user performance of a laparoscopic training task with the surgical training model 100.

In some embodiments, the amount of force (i.e. pre-determined force threshold) required to dislodge the post from the peg associated with the body 110 in one direction (e.g., towards the left in FIG. 16B) may differ from other directions or may be incapable of dislodging at all (e.g., towards the right in FIG. 16B). Thus, based on the location of the removable connection between the platform 1600 and the peg 1620 and the direction in which the post 130 is being pulled on, the surgical training model 100 can control whether the force being exerted on the post 130 will activate the force perception mechanism 140.

It should be noted that the embodiments associated with components implementing the force perception mechanism 140 with the post 130 are compatible with the components implementing the force perception mechanism 140 with the limbs (or the body 110 as a whole) of the surgical training model 100. These two different portions of the surgical training model 100 may have their force perception mechanisms 140 operate independent from each other (e.g., forces on the post 130 cannot cause the body 110 to disengage from its pegs and vice versa) which allows users the ability to focus on a particular portion of the surgical training model 100. However, other embodiments allow the force perception mechanisms 140 of the posts 130 and the limbs/body 110 to operate together (e.g., forces on the post 130 can be transferred to nearby components associated with the force perception mechanism 140 associated with limbs/bodies 110 and vice versa). The latter embodiments could raise the difficulty for various laparoscopic training tasks as users would now need to be cognizant of forces being applied to one portion of the surgical training model 100 affecting other portions of the surgical training model 100.

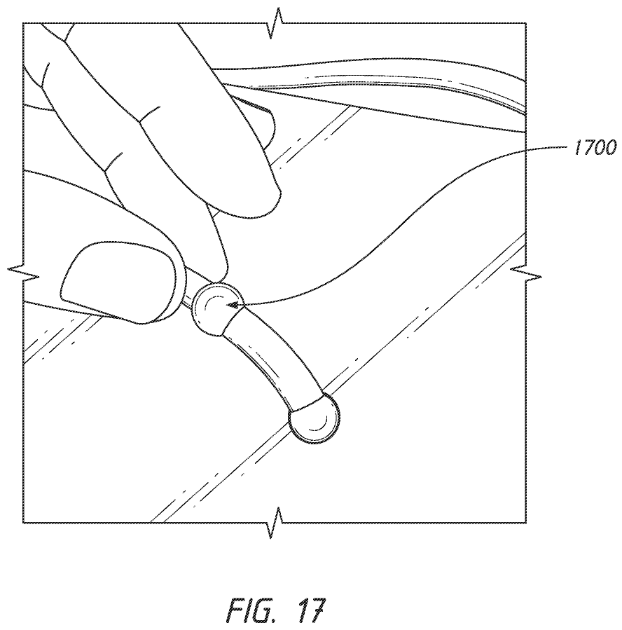

FIG. 17 illustrates another embodiment of a surgical training model 100 using a force perception mechanism 140. In particular, the surgical training model 100 incorporates an indicator or protrusion that corresponds to a portion of a post 130 that has a cross section that is larger than the cross section of nearby sections of the post 130; and larger than the opening in the base 120 that it goes through. The protrusion 1700 on the post 130 is positioned beneath the base 120 such that when force is applied to the post 130, the protrusion 1700 can be pulled above the base 120 and become exposed via the opening in the base 120. For example, as illustrated in FIG. 17, the post 130 may have one or more protrusion 1700 that have a larger cross-sectional area compared to adjacent sections of the post 130. These protrusions 1700 associated with the post 130 are initially hidden underneath the base. As the user exerts force on the post 130, the protrusions 1700 can be used to indicate to the user when excessive force is detected when one or more of the protrusions 1700 are pulled through the opening of the base 120. With the reveal of the protrusion 1700, the user would be visually informed that excessive force was detected. Additional haptic feedback and audio feedback can also be possible with the protrusion 1700 being pulled through the opening. For example, the haptic feedback (e.g., jolt or some sudden movement) can be associated with the protrusion 1700 being pulled through the opening. In various embodiments, the haptic feedback for the protrusion may be associated with a resistance/friction of the base 120 pushing against the protrusion 1700 initially and that resistance/friction giving away once the protrusion 1700 passes through the opening of the base 120. Furthermore, in various embodiments, a sound (e.g., pop) may be associated with the protrusion 1700 being pulled through the opening of the base 120. In each of these cases, the haptic and/or audio feedback can also provide additional ways that the user can be informed that excessive force was used in the laparoscopic training task.

In some embodiments, the post 130 may have a stopper (not shown) that is located at the distal end of the post that is further below the post 130 compared to the protrusions 1700. The stopper would be used to prevent the post 130 from being completely dislodged from the base 120. However, in other embodiments, the stopper may not be present which would allow the user to completely dislodge the post 130 from the base 120 when excessive force is applied to the post 130. Such a condition could be used as an indicator that excessive force was detected and also transform the surgical training model 100 into an inoperable state thereby preventing further performance of a laparoscopic training task.

In the various embodiments described above, the force perception mechanism 140 provides a non-electronic way for users to be notified (e.g., visually, haptically, audio) when excessive force or a force beyond a predetermined threshold has been applied to a surgical training model 100. This allows users to train, learn, and adapt to the use of laparoscopic devices (e.g., graspers, dissectors) so as to manage the force applied to tissue during a laparoscopic procedure thereby minimizing/preventing trauma to tissue caused from such excessive forces.

To further simulate laparoscopic surgery, a laparoscopic trainer can also be used with the surgical training models. FIG. 18 illustrates an example embodiment of a laparoscopic trainer. The laparoscopic trainer 1800 is designed for practicing laparoscopic or other minimally invasive surgical procedures. In particular, the laparoscopic trainer 1800 can be designed to mimic a torso or abdominal region of a patient.

The laparoscopic trainer 1800 includes a body cavity 1805 that is substantially obscured from the user via, for example, the top cover 1815. The body cavity 1805 is configured to receive simulated or live tissue or model organs or training models. As applicable for this present disclosure, the body cavity 1805 would be adapted to receive any one of the above described surgical training models (as illustrated in FIGS. 1-17). An exemplary embodiment is illustrated in FIG. 19 where the body cavity 1805 is shown to house an exemplary surgical training model 100 in accordance with various embodiments as disclosed throughout the description. The body cavity 1805 is accessible via a tissue simulation region 1810 that is configured to be penetrated by the user employing laparoscopic devices (e.g., graspers, dissectors) for the practice of surgical techniques or laparoscopic training task on the surgical training, tissue or practice model located in the body cavity 1805. Although the body cavity 1805 is shown to be accessible through the tissue simulation region 1810, other means of accessing the body cavity 1805 are also possible. For example, a hand-assisted access device or single-site port system can also be used with the laparoscopic trainer 1800 in order to access the body cavity 1805. Further exemplary laparoscopic trainers are also described in U.S. patent application Ser. No. 13/248,449 entitled “Portable Laparoscopic Trainer” filed on Sep. 29, 2011 and U.S. patent application Ser. No. 15/895,707 entitled “Laparoscopic Training System” filed on Feb. 13, 2018, both of which are incorporated herein by reference in their entirety.

The laparoscopic trainer 1800 includes a top cover 1815 that is connected to and spaced apart from a trainer base 1820 by at least one leg 1825. In some embodiments, for example such as the one illustrated in FIG. 18, the laparoscopic trainer 1800 may have multiple legs 1825. As mentioned above, in an embodiment, the surgical training device 1800 can be configured to mimic the torso of a patient. The top cover 1815 is representative of an anterior surface of the patient and the space between the top cover 1815 and the trainer base 1820 is representative of an interior of the patient or the body cavity 1805 where organs would generally reside. As such, the laparoscopic trainer 1800 is a useful tool for teaching, practicing, and demonstrating various surgical procedures and their related instruments in simulation of a patient undergoing a surgical procedure.

In some embodiments, surgical instruments are inserted into the body cavity 1805 through the tissue simulation region 1810. In other embodiments, the surgical instruments can also be inserted into pre-established apertures 1830 in the top cover 1815. In each of these embodiments, various tools and techniques may be used to penetrate the top cover 1815 to perform mock procedures on simulated organs or practice models, e.g., a surgical training model 100, placed within the body cavity 1805 (i.e. space between the top cover 1815 and the trainer base 1820).

In some embodiments, the trainer base 1820 can include a model-receiving area 1835 or tray. The model-receiving area 1835 or tray is designed for staging or holding a simulated tissue model or live tissue as well as other practice models such as the surgical training models described herein. In some embodiments, the model-receiving area 1835 of the trainer base 1820 may include frame-like elements for holding a model in place. To help retain a simulated tissue model or live organs or practice model, e.g., a surgical training model 100, on the trainer base 1820, a retractable wire can be attached to the model and a clip. The clip can then be attached to the trainer base 1820 at locations 1840. The retractable wire is extended and clipped to hold the tissue model in position substantially beneath the tissue simulation region 1810. Other means for retaining a model (e.g., tissue, live, practicing, or surgical training) include a patch of hook-and-loop type fastening material (VELCRO®) affixed to the trainer base 1820 in the model receiving area 1835 such that it is removably connectable to a complementary piece of hook-and-loop type fastening material (VELCRO®) affixed to the model.

The retaining means allows the surgical training models to remain fixed to the bottom of the laparoscopic trainer when the user interacts with the surgical training model 100 during any number of different laparoscopic training tasks. Various benefits for keeping the surgical training models fixed is that vision of the surgical training model is not moved outside the vision of any webcams or other video capturing devices which have been set up to capture images inside the laparoscopic trainer. Otherwise, the user may be required to readjust the model and/or the video capturing devices when the surgical training model 100 is inadvertently moved during the laparoscopic training task. In other embodiments, the surgical training model 100 is not attached or loosely attached to the trainer base of the laparoscopic trainer to vary the difficulty and/or operational use of the surgical training model 100 and/or surgical instruments associated therewith.

In some embodiments, a video display monitor 1845 can be provided that is hinged to the top cover 1815. The video display monitor 1845 is shown in a closed orientation in FIG. 18. The video monitor 1845 is connectable to a variety of visual systems for delivering an image to the video monitor 1845. For example, a laparoscope inserted through one of the pre-established apertures 1830 or a webcam located in the body cavity 1805 (used to observe the simulated procedure) can be connected to the video monitor 1845 and/or a mobile computing device (not shown) to provide an image to the user. Also, audio recording or delivery means may also be provided and integrated with the laparoscopic trainer 1800 to provide audio and visual capabilities. Means for connecting a portable memory storage device such as a flash drive, smart phone, digital audio or video player, or other digital mobile device is also provided, to record training procedures and/or play back pre-recorded videos on the monitor for demonstration purposes. The connection means for providing an audio-visual output to a screen larger than the video monitor 1845 is also possible and can be provided for the laparoscopic trainer 1800 in various embodiments. In another embodiment, the top cover 1815 may not include the video monitor 1845 but may instead contain features that allow for the connection of the laparoscopic trainer 1800 with a laptop computer, a mobile digital device or tablet where the audio visual output can be viewed. The connection features can be wired and/or wireless.

When assembled, the top cover 1815 is positioned directly above the trainer base 1820 with the legs 1825 located substantially around the periphery and interconnected between the top cover 1815 and the trainer base 1820. The top cover 1815 and the trainer base 1820 are substantially the same shape and size and have substantially the same peripheral outline. The internal cavity 1805 is partially or entirely obscured from view. In an embodiment (as illustrated in FIG. 18), the legs 1825 may include openings to allow ambient light to illuminate the internal cavity 1805 as much as possible. Furthermore, the openings of the legs 1825 may also advantageously provide weight reduction for the laparoscopic trainer 1800 as possible for convenient portability. In some embodiments, the top cover 1815 is removable from the legs 1825 which in turn are removable or collapsible via hinges or the like with respect to the trainer base 1820. This allows the unassembled trainer 1800 to have a reduced weight that provides for easier portability.

In accordance with various embodiments, the surgical training systems described herein includes a model that is configured to facilitate in the training of force perception usable during surgical procedures. The present disclosure describes various embodiments which each contain variations to one or more of the body, post, components implementing force perception mechanisms, and/or a base which offer different features for the surgical training model which users can interact with when performing laparoscopic training tasks with the surgical training model.

In accordance with various embodiments, the surgical training model comprises a post, a body (comprising one or more limbs), components implementing force perception mechanisms, bases, or any combination thereof. In various embodiments, the posts may be an elongate tube. In various embodiments, one or more of the posts, bodies or any combination thereof may be made of an elastomeric material. In various embodiments, one or more of the posts, bodies or any combination thereof may be made of silicone and in various embodiments, may be made of the same material. In various embodiments, one or more of the posts, bodies or any combination thereof are stretchable, flexible and/or bendable. In various embodiments, the posts have a proximal portion that is fixed relative to one or more of the bodies and/or bases and a distal portion that is bendable relative to the one or more of the bodies and/or bases. In various embodiments, the posts have a proximal portion that extends away from one or more bodies and/or bases and a distal portion that curves back towards the one or more bodies and/or bases.

One or more bodies, in various embodiments, comprises one or more limbs. In various embodiments, a body comprises a center portion from which one or more limbs extends. In various embodiments, the posts have a length that is longer than one or more limbs of the body. In various embodiments, the posts are stretchable to a length that is longer than one or more limbs of the body. In various embodiments, one or more of the posts, limbs and/or any combination thereof are bendable and/or movable to contact and/or interact with each other. In various embodiments, the posts have a thickness or defines a cross-section that is greater than a thickness or cross-section of the one or more bodies.

In various embodiments, the posts are configured to be connected with the body via an opening located at/near the center of the body. The post may include a stopper that is configured to prevent the post from being pulled completely through the body. In various embodiments, the post may include rings, markings, or other portions that have a cross-sectional area that is different (i.e. larger) from the cross-sectional area of adjacent portions of the post that allow for identification of when excessive force has been detected. In various embodiments, the post may be stretchable. In various embodiments, the post may be more rigid. In various embodiments, the post may not include the stopper so that excessive forces applied to the post (via the user pulling on the post using laparoscopic instruments) may cause the post to be detached from the base and/or body.

Various embodiments of surgical training models having different force perception mechanisms are contemplated. In some embodiments, a surgical training model can utilize one or more force perception mechanisms that are configured to detect excessive forces applied to the body or limbs of the surgical training model. In particular, the force perception mechanisms may correspond to pegs associated with the base of the surgical training model and the interface (e.g., connection) with the body via openings associated with the bodies. A force threshold associated with the connection between the structure and the body corresponds to an amount of force that is allowable before the body becomes detached from the structure. The force threshold is used as a means for identifying an allowable amount of force corresponding to an amount of force that would cause trauma or damage during an actual surgical procedure.

When excessive force is exerted on the body (e.g., limb), this may cause the body to become detached from one or more of components implementing force perception mechanisms. The detachment of the body from one or more of components implementing force perception mechanisms not only identifies the condition that excessive force was detected but can also be used to transform the surgical training model from an initial first state to a transformed state which renders the surgical training model inoperable. Thus, while the user is performing a laparoscopic training task with the surgical training model, the transformation into the secondary or transformed state serves as an identifier which prevents the user from further progressing the laparoscopic training task. However, the surgical training model is configured to be resettable back to its initial first state to allow the user to perform the laparoscopic training task again.

In various embodiments, the force perception mechanism may comprise a tether that is attached to both the base and the body (e.g., limb). In various embodiments, the tether may have a width and length that is smaller than the limb such that in an initial first state of the surgical training model, the strip or tether may be hidden beneath the limb. The tether, in various embodiments, may be removably connected to the base. When the tether becomes detached from the base, this detachment can be used as an indicator that an excessive amount of force has been applied to the limb.

In a further embodiment an end of the tether may have an opening so that it can be attached to the base via the use of a peg. The connection between the tether and the peg has an associated force threshold that can be used to detect excessive forces being exerted on the body/limb.

In various embodiments, the surgical training model may include one or more rods that are associated with the base and are configured to connect with the body (e.g., limb) via openings. The one or more rods are configured to hold the body (e.g., limb) in place until the user chooses to operate on that particular limb.

In various embodiments, the body may comprise a plurality of limbs that extend away from the center of the surgical training model. However, other embodiments are contemplated whereby the surgical training model comprises a plurality of independent limbs. In some embodiments, at least one of the ends of the limbs may be attached to the base. In other embodiments, the entirety of the limb may be removably attached to the base.

In some embodiments, the tether may have markings that can be used to gauge and identify an excessive amount of force being applied to the body/limb. The marking on the tether may be initially hidden, for example, beneath the base. As force is applied to the limb, the tether may become stretched or be pulled above the base. At some point, the marking may be exposed to the user thereby indicating that an excessive amount of force has been detected on the limb.

As with the tether, similar markings can be applied to the post in order to gauge and detect when excessive amount of force is being applied to the post. The markings, in various embodiments, may be situated at a pre-determined point, for example, at/near the base. As force is being applied on the post, the post may be configured to stretch thereby moving the location of the marking away from the base. A distance that the marking moves from the base can be used to gauge how much force is being applied on the post and whether an excessive amount of force has been detected.

Aside from markings, in various embodiments, other objects such as rings or protrusions can be applied to the tether and/or post in order to gauge and amount of force being applied and whether an excessive amount of force is detected. The rings or protrusions provide visual indicators as to how far the post or tether is being stretched and can be used to gauge and detect an amount of force being exerted on the tether or post.

In various embodiments, the post may include other features such as flaps, strips, platforms, attachments, or any combination thereof that allow the post to be connected to the base and/or body. These flaps, strips, platforms, attachments, or any combination thereof may be separately manufactured and subsequently attached to the post. In some embodiments, the flaps, strips, platforms, attachments, or any combination thereof can be manufactured with the post as one structure. In various embodiments, the post may utilize two or more of the flaps, strips, platforms, attachments, or any combination thereof together in one embodiment.

To form the connection between the post and the base/body, some embodiments may use adhesives to connect the flaps, strips, platforms, attachments, or any combination thereof of the post to the base/body. In other embodiments, the connection may be via the friction in the openings associated with the flaps, strips, platforms, attachments, or any combination thereof and pegs associated with the base/body. The detachment of the one or more of the flaps, strips, platforms, attachments, or any combination thereof from the base and/or body is used as an identification of when an excessive amount of force has been exerted and detected on the post.

In various embodiments, a surgical trainer can be provided which is configured to simulate an insufflated torso or abdominal region of a patient during laparoscopic surgery. The surgical trainer comprises a top, bottom, and a plurality of legs which forms the enclosure or body cavity. The user's direct vision of any models housed within the surgical trainer is obstructed thereby requiring the user to rely on indirect images obtained via, for example, cameras internal to the surgical trainer and which are displayed on a display screen outside of the surgical trainer. The surgical trainer is configured to house one or more different models (as described above) within the body cavity. The surgical trainer is configured to allow one or more laparoscopic devices into the surgical trainer through the top cover, for example, at pre-determined locations or through apertures set within the top cover.

Although the present invention has been described in certain specific aspects, many additional modifications and variations would be apparent to those skilled in the art. It is therefore to be understood that the present invention may be practiced otherwise than specifically described, including various changes in the size, shape, and materials, without departing from the scope and spirit of the present invention. For example, one of ordinary skill in the art should be able to use the examples to derive a variety of different implementations which retain the main functionalities of the surgical training models using force perception mechanisms described throughout the present disclosure. Although some of the embodiments utilize descriptions which are specific to structural and/or method-related steps, it is to be understood that such subject matter are not necessarily limited to the specifics (e.g., functionality for a feature can be distributed differently over more than one component or be performed in a combination of components different from what was identified explicitly above). Thus, embodiments of the present invention should be considered in all respects as illustrative and not restrictive.

The above description is also provided to enable any person skilled in the art to make and use the devices or systems and perform the methods described herein and sets forth the best modes contemplated by the inventors of carrying out their inventions. Various modifications, however, will remain apparent to those skilled in the art. It is contemplated that these modifications are within the scope of the present disclosure. Different embodiments or aspects of such embodiments may be shown in various figures and described throughout the specification. However, it should be noted that although shown or described separately each embodiment and aspects thereof may be combined with one or more of the other embodiments and aspects thereof unless expressly stated otherwise. It is merely for easing readability of the specification that each combination is not expressly set forth.

1. A surgical training model for developing and practicing skills associated with laparoscopic surgical procedures, the model comprising a force perception mechanism has a first state and a second state, wherein in the first state, the force perception mechanism is at least partially attached to the model, wherein in the second state, the force perception mechanism is detached from the model, and wherein a transition from the first state to the second state notifies a user when an amount of force being applied to the model exceeds a pre-determined amount.

2. The surgical training model of claim 1, wherein the model comprises a body and a post.

3. The surgical training model of claim 1, wherein the force perception mechanism comprises a peg that is inserted through a hole in the body of the model.

4. The surgical training model of claim 3, wherein the peg has an interference-type fit with the hole in the body of the model.

5. The surgical training model of claim 1, wherein the force perception mechanism comprises a tether that is attached between the model and a base, wherein the model sits on top of the base.

6. The surgical training model of claim 5, wherein the tether is removably attached with the model and/or the base.

7. The surgical training model of claim 1, wherein the post comprises an indicator or protrusion.

8. The surgical training model of claim 7, wherein the indicator is a visible marking made on the post.

9. The surgical training model of claim 1, wherein the model is configured to be housed within an enclosure of a surgical trainer, the surgical trainer comprising a top, a bottom, and a plurality of legs which define the enclosure of the surgical trainer, the surgical trainer being configured to obstruct direct vision into the enclosure.

10. A surgical training model for developing and practicing skills associated with laparoscopic surgical procedures, the model comprising:
a post; and
a force perception mechanism comprising a peg and a body, the force perception mechanism comprising a first state and a second state, wherein in the first state the peg is connected to the body, wherein in the second state the peg is detached from the body, and wherein a transition from the first state to the second state notifies a user when an amount of force being applied to the model via the post and/or the body exceeds a pre-determined amount.

11. The surgical training model of claim 10, wherein the body comprises one or more limbs, and wherein the peg is connected to at least one of the one or more limbs via a hole positioned at a pre-determined location on the one or more limbs.

12. The surgical training model of claim 10, wherein the peg is removably connected to the hole having an interference-type connection which provides friction that prevents the peg from disengaging with the body up to a pre-determined amount of force.

13. The surgical training model of claim 11, wherein at least one of the one or more limbs has a plurality of holes located along the length of that limb, wherein the model comprises two or more pegs that are configured to removably connect with two or more of the plurality of holes, and wherein the second state corresponds to at least one of the pegs becoming detached from the body.

14. A surgical training model for identifying when an amount of force exceeding a pre-determined amount is being applied during a simulated surgical procedure, the model comprising:
a base; and
a body, wherein a portion of the body is configured to be removably attached to the base at a pre-determined location;
wherein the model has two states: a first state in which the portion of the body is attached to a portion of the base at the pre-determined location, and a second state in which the portion of the body is detached from the portion of the base at the pre-determined location, and wherein a transition between the first state and the second state informs a user that the force being applied to the model exceeds the pre-determined amount.

15. The surgical training model of claim 14, wherein the body is removably attached to the base via a tether, wherein the pre-determined location on the base corresponds to a location of a slot, and wherein the tether is attached at one end to the portion of the body and on an opposite end of the tether is passed through the slot and attached beneath the base.

16. The surgical training model of claim 15, wherein the tether further comprises an indicator positioned on a portion beneath the base that is configured to be pulled to a visible position through the slot when the amount of force exceeds the pre-determined amount.

17. The surgical training model of claim 14, wherein the base further comprises a peg and the pre-determined location on the base also corresponds to a location of the peg, and wherein the portion of the body comprises a hole that is configured to receive the peg.

18. The surgical training model of claim 14, wherein the body is removably attached to the base via a flap, wherein the base comprises a slot and the pre-determined location on the base corresponds to a location of the slot, and wherein the flap that is attached to the body is configured to be inserted into the slot in the base.

19. The surgical training model of claim 14, wherein the pre-determined amount of force is customizable based on an amount of friction associated with a removable attachment between the portion of the body and the base at the pre-determined location.
